(19) United States
(12) Patent Application Publication
(10) Pub. No.: US 2026/0065553 A1
(43) Pub. Date: Mar. 5, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: TAKAYUKI YAMADA, Kanagawa (JP); SHINJIRO HORI, Kanagawa (JP); KOUTA MURASAWA, Kanagawa (JP); KAZUYA OGASAWARA, Kanagawa (JP); FUMINO MATSUI, Kanagawa (JP)

(21) Appl. No.: 19/314,038

(22) Filed: Aug. 29, 2025

(30) Foreign Application Priority Data
Sep. 5, 2024 (JP) 2024-153373

(51) Int. Cl. G06T 11/60; G06T 3/40

(52) U.S. Cl. CPC G06T 11/60; G06T 3/40; G06T 2200/24

(57) ABSTRACT

An information processing apparatus according to the present disclosure is an information processing apparatus configured to generate creation product data, and includes a generation unit configured to generate second creation product data including background information of first creation product data and varying from the first creation product data at least in size, and the generation unit generates background information of the second creation product data by enlarging or reducing the background information of the first creation product data such that a size ratio between the background information of the first creation product data and the background information of the second creation product data takes a value between 1 and a ratio between a size of the first creation product data and a size of the second creation product data.

### BACKGROUND

### Field of the Technology

The present disclosure relates to an information processing apparatus, an information processing method, and a storage medium.

### Description of the Related Art

There has been conventionally proposed a method in which a template storing information such as shapes and arrangement of images, characters, graphics, and the like forming a poster is prepared, and an information processing apparatus arranges images, characters, graphics, and the like according to the template to generate a poster.

Japanese Patent Laid-Open No. 2017-059123 (Patent Literature 1) describes a system in which a postcard is generated by selecting templates in ascending order of a difference between an impression evaluation value of each template and an impression evaluation value of an image to be arranged in the template.

### SUMMARY

An object of the present disclosure is to generate creation product data by which impressions of multiple creation products are brought closer to each other.

An information processing apparatus according to the present disclosure is an information processing apparatus configured to generate creation product data, the information processing apparatus comprising:
one or more memories; and
one or more processors storing instructions to cause the one or more processors to function as a generation unit configured to generate second creation product data including background information of first creation product data and varying from the first creation product data at least in size, wherein the generation unit generates background information of the second creation product data by enlarging or reducing the background information of the first creation product data such that a size ratio between the background information of the first creation product data and the background information of the second creation product data takes a value between 1 and a ratio between a size of the first creation product data and a size of the second creation product data, in a case where the size of the second creation product data is smaller than the size of the first creation product data, a size of the background information of the second creation product data is smaller than a size of the background information of the first creation product data, and is larger than a size of the background information of the first creation product data that is reduced by the ratio of the size of the second creation product data to the size of the first creation product data, and in a case where the size of the second creation product data is larger than the size of the first creation product data, the size of the background information of the second creation product data is larger than the size of the background information of the first creation product data, and is smaller than a size of the background information of the first creation product data that is enlarged by the ratio of the size of the second creation product data to the size of the first creation product data.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of hardware of a commercial product generation apparatus.

FIG. 2 is a software block diagram of a commercial product creation application.

FIGS. 3A and 3B are diagrams explaining a skeleton.

FIGS. 4A to 4F are diagrams explaining background patterns.

FIG. 5 is a diagram explaining a color scheme pattern.

FIG. 6 is a diagram illustrating an application launch screen provided by the commercial product creation application.

FIGS. 7A to 7D are diagrams illustrating preview screens provided by the commercial product creation application.

FIG. 8 is a flowchart illustrating an impression quantification process.

FIG. 9 is a diagram explaining impression subjective evaluation.

FIGS. 10A to 10D are flowcharts illustrating a commercial product generation process.

FIGS. 11A to 11D are diagrams explaining color scheme lists.

FIGS. 12A and 12B are diagrams explaining obtaining of a color scheme pattern.

FIG. 13 is a diagram explaining color scheme subjective evaluation.

FIGS. 14A to 14C are diagrams explaining a skeleton selection method.

FIG. 15 is a diagram explaining a color scheme pattern selection method.

FIGS. 16A to 16E are diagrams explaining scaling of the background pattern.

FIGS. 17A to 17F are diagrams explaining complementing and adjusting of the background pattern.

FIG. 18 is a diagram explaining a font selection method.

FIG. 19 is a software block diagram explaining a layout component in detail.

FIG. 20 is a flowchart illustrating a layout process.

FIGS. 21A to 21C are diagrams explaining input of the layout component.

FIGS. 22A to 22D are diagrams explaining an operation of the layout component.

FIG. 23 is a diagram illustrating a modified example of the preview screen provided by the commercial product creation application.

FIG. 24 is a software block diagram of a commercial product creation application in a second embodiment.

FIG. 25 is a flowchart illustrating a commercial product generation process of the second embodiment.

FIGS. 26A to 26E are diagrams explaining a combination generation component.

FIGS. 27A and 27B are diagrams explaining the combination generation component.

### DESCRIPTION OF THE EMBODIMENTS

In a step of creating creation products (commercial products) such as a postcard, a poster, and a flyer, a common design is spread across various types of commercial products to give customers an impression of a brand of stores and goods. However, there is a case where differences in appearance of the common design among the multiple creation products are not taken into consideration. For example, assume a case where a common design (for example, the same background information (background pattern)) is used in multiple creation products. In the case where the sizes of the creation products vary in this case, impressions given by the multiple creation products vary in some cases.

Embodiments of the present disclosure are explained below in detail with reference to the attached drawings. Note that the following embodiments do not limit the present disclosure according to the scope of claims, and not all of combinations of features explained in the present embodiments are necessarily essential for solving means of the present disclosure. Note that identical constituent elements are denoted by identical reference numerals, and explanation thereof is omitted.

In each of the embodiments described below, explanation is given of a method in which an application for creating a creation product such as a commercial product (hereinafter, also referred to as “commercial product creation application”) is operated in an information processing apparatus to generate automatically-designed creation product data. Note that the creation product data is also referred to as “commercial product data” in the present specification.

In the present specification, the “commercial product” includes creation products such as a poster, a pamphlet, a menu, a postcard, a flyer, a banner, a business card, a shop card, an invitation, and a membership card, and is used as, for example, an advertising medium. Moreover, the “commercial product” includes any creation product that includes at least one of an image content and a text content. Furthermore, data of the creation product (commercial product data) may not only be outputted as print data and used by being printed, but also used as electronic contents in a web site, an SNS, a virtual space, or the like.

In the present specification, “brand” expresses an identity (corporate mission, vision, principle, or characteristics) of a corporation or a store by using designs. In order to cause the brand to be widely recognized by customers, it is necessary to spread designs with a consistent style across various commercial products and transmit a message to the customers. In other words, designs with uniform feel having a consistent style are important for popular recognition of the brand. To this end, it is necessary to use designs with uniform feel for product packages, store designs, and advertisement commercial products (web site, pamphlet, poster, business card, postcard, and the like) which are points of contact with the customers. In order to achieve designs with uniform feel, multiple commercial products need to include similar design elements. The design elements are elements forming the designs, and include, for example, a logo (symbol mark), a font, a pattern, and a color of the brand. Using these design elements commonly in multiple commercial products allows the commercial products to give uniform feel, and causes the customers to recognize a consistent style.

In the following embodiments, explanation is given of a commercial product generation apparatus configured to generate commercial product data with a design that gives uniform feel in multiple commercial products varying in size or type and that expresses an impression of a brand intended by a user.

### First Embodiment

In a first embodiment, explanation is given of a method in which an application (hereinafter, also referred to as “commercial product creation application”) is operated to generate commercial product data of multiple varying commercial products in an information processing apparatus. Note that, in the following explanation, “image” includes a still image captured with a camera, a frame image cut out from a video, and an illustration created with a paint tool or the like, unless otherwise noted. Moreover, an information processing apparatus in which the commercial product creation application is installed is referred to as commercial product generation apparatus.

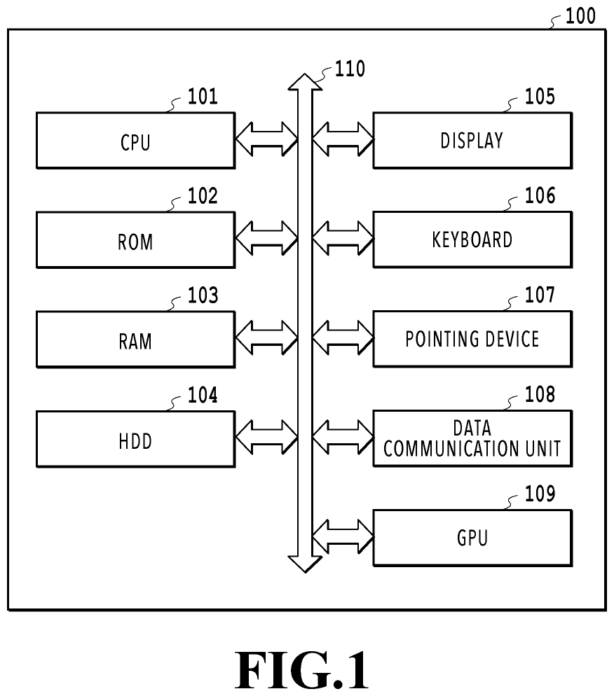

FIG. 1 is a block diagram illustrating a configuration of hardware of a commercial product generation apparatus 100. Note that the commercial product generation apparatus 100 is an information processing apparatus, and examples thereof include a personal computer (hereinafter, described as PC), a smartphone, a tablet, and the like. In the present embodiment, the commercial product generation apparatus 100 is explained as a PC. The commercial product generation apparatus 100 includes a CPU 101, a ROM 102, a RAM 103, an HDD 104, a display 105, a keyboard 106, a pointing device 107, a data communication unit 108, and a GPU 109.

A CPU (central processing unit/processor) 101 integrally controls the commercial product generation apparatus 100, and implements operations of the present embodiment by, for example, reading out programs stored in the ROM 102 to the RAM 103 and executing the program. Although there is one CPU in FIG. 1, multiple CPUs may be provided.

The ROM 102 is a general-purpose ROM, and for example, programs to be executed by the CPU 101 are stored in the ROM 102. The RAM 103 is a general-purpose RAM, and is used as, for example, a working memory for temporarily storing various pieces of information in execution of the programs by the CPU 101.

The HDD (hard disk) 104 is a storage medium (storage unit) for storing an image file, a database holding processing results of image analysis and the like, a skeleton to be used by the commercial product creation application, and the like.

The display 105 is a display unit configured to display a user interface (UI) of the present embodiment and data of the commercial product that is a layout result of image data (hereinafter, also referred to as “image”) and a text, to the user. The keyboard 106 and the pointing device 107 receive instruction operations from the user. The display 105 may have a touch sensor function.

For example, the keyboard 106 is used in the case where the user inputs generation conditions of a commercial product desired to be created on the UI displayed on the display 105.

For example, the pointing device 107 is used in the case where the user clicks a button on the UI displayed on the display 105.

The data communication unit 108 communicates with an external apparatus via a wired network, a wireless network, or the like. For example, the data communication unit 108 transmits data subjected to layout by an automatic layout function, to a printer or a server capable of communicating with the commercial product generation apparatus 100.

The GPU 109 is a processor that performs an image process by receiving a command from the CPU 101. For example, the GPU 109 generates commercial product data by analyzing images to be arranged in the commercial product, estimating impressions of images or texts, estimating an impression of each of design elements, estimating an impression of the commercial product, and executing color scheme assignment and layout of images, texts, and the like on a skeleton.

A data bus 110 communicably connects the blocks of FIG. 1 to one another. Note that the configuration illustrated in FIG. 1 is merely an example, and the present disclosure is not limited to this. For example, the commercial product generation apparatus 100 may include no display 105, and display the UI on an external display.

The commercial product creation application in the present embodiment is saved in the HDD 104. The commercial product creation application is activated in the case where the user executes an operation such as a click or a double click on an icon of the application displayed on the display 105 with the pointing device 107.

### <Software Block Diagram>

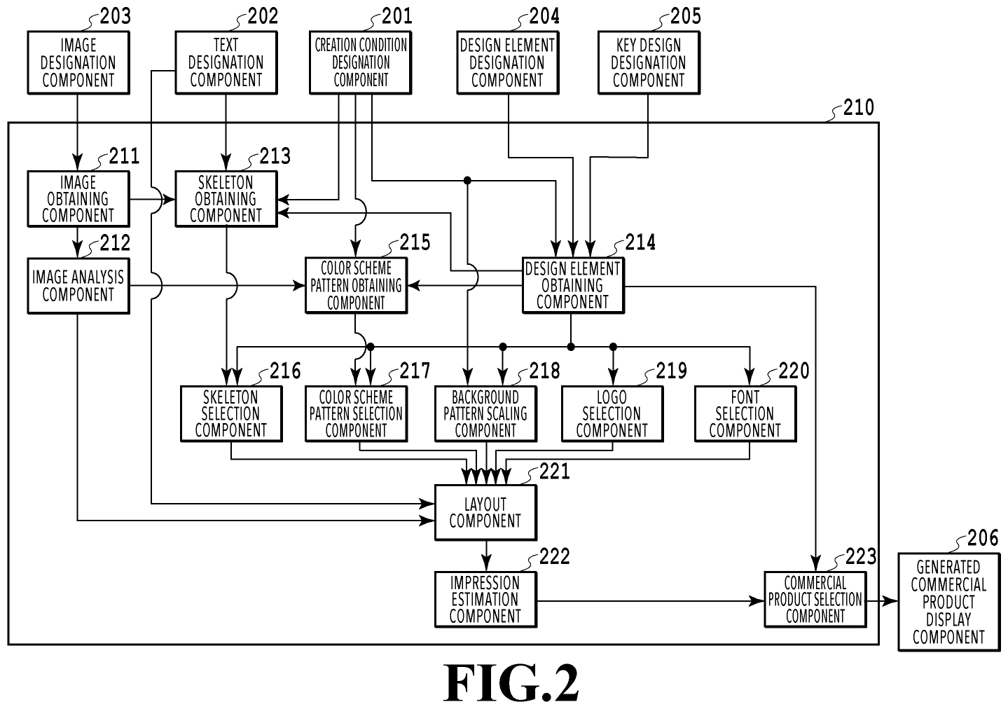

FIG. 2 is a software block diagram of the commercial product creation application. The commercial product creation application includes a creation condition designation component 201, a text designation component 202, an image designation component 203, a design element designation component 204, a key design designation component 205, a generated commercial product display component 206, and a commercial product generation component 210. The commercial product generation component 210 includes an image obtaining component 211, an image analysis component 212, a skeleton obtaining component 213, a design element obtaining component 214, a color scheme pattern obtaining component 215, a skeleton selection component 216, a color scheme pattern selection component 217, a background pattern scaling component 218, a logo selection component 219, a font selection component 220, a layout component 221, an impression estimation component 222, and a commercial product selection component 223.

In the case where the commercial product creation application is installed into the commercial product generation apparatus 100, an launch icon is displayed on a top screen (desktop) of an operating system (OS) operating on the commercial product generation apparatus 100. The user operates the launch icon displayed on the display 105 with the pointing device 107. A program of the commercial product creation application saved in the HDD 104 is loaded onto the RAM 103 in response to this operation, and is executed by the CPU 101. The commercial product creation application is thereby activated.

Program modules corresponding to the respective components illustrated in FIG. 2 are included in the above-mentioned commercial product creation application. The CPU 101 executes each of the program modules to function as a corresponding one of the components illustrated in FIG. 2. Hereinafter, as explanation of the constituent elements illustrated in FIG. 2, the components are explained to execute various processes according to the program. Moreover, FIG. 2 particularly illustrates a software block diagram relating to the commercial product generation component 210 configured to execute a function of automatically creating multiple commercial products.

The creation condition designation component 201 designates creation conditions of the commercial product depending on a UI operation performed with the pointing device 107, for the commercial product generation component 210. In the present embodiment, a type, a use application category, and an expected viewing distance of each of multiple commercial products to be created are designated as the creation conditions. The size of each commercial product may be set in association with the type of the commercial product in advance, or designation of the size by the user may be received. Moreover, designation of multiple sizes may be received depending on the commercial product. In this case, the user may designate actual dimensional values of width and height or a sheet size such as A1 or A2. The use application category is a category indicating a use application in which the commercial product is to be used, and is, for example, restaurant, school event, sale, and the like. The creation condition designation component 201 outputs the designated creation conditions to the skeleton obtaining component 213, the color scheme pattern obtaining component 215, the design element obtaining component 214, and the background pattern scaling component 218.

The text designation component 202 receives designation of character information to be arranged in the commercial product, the designation performed by the user by performing a UI operation with the keyboard 106. The character information to be arranged in the commercial product is, for example, character strings representing title, time, date, location, and the like in the case where the commercial product is a poster. The character information is associated with a type of character information. The type of character information is information indicating the type (tag or attribute information) such as information indicating whether the character information is information indicating a title or information indicating time, date, and location, and is associated with each piece of character information. The type of character information may change depending on the type of creation commercial product that is selected in the creation condition designation component 201. For example, in the case where a poster is selected, the types of character information are assumed to be “title”, “subtitle”, and “main text”. Moreover, in the case where a postcard is selected, the types of character information are assumed to be “title”, “address”, and “contact”. In the case where multiple commercial products are selected as creation targets, the character information that is redundant between the multiple commercial products may be designated separately for each commercial product, or designated in a batch for the multiple commercial products. The text designation component 202 associates each piece of character information with the type of character information, and outputs the character information and the type to the skeleton obtaining component 213 and the layout component 221.

The image designation component 203 receives designation, by the user, of one or multiple pieces of image data to be arranged in the commercial product. The designation of image data can be performed based on a structure of a file system including the image data such as a device or a directory. Moreover, the designation of image data may also be performed based on attribute information or additional information for identifying an image such as shooting date/time. Furthermore, the image designation component 203 may designate image data (hereinafter, also referred to as “application material image”) included in the commercial product creation application and provided as a material. Moreover, the image designation component 203 may designate image data (hereinafter, also referred to as “cooperation material image”) included in an external image providing service cooperating with the commercial product creation application. The image designation component 203 outputs file paths of the designated image and the generated image to the image obtaining component 211.

The design element designation component 204 receives designation of design elements to be reflected in the commercial product being the generation target (hereinafter, referred to as creation commercial product), from the user. The design elements for which the designation is received include at least a target impression, and further include at least one of color scheme, background information (hereinafter, referred to as background pattern), a logo, and a font. In the present embodiment, the target impression, the color scheme, the background pattern, the logo, and the font can be designated. Moreover, the design element designation component 204 receives designation of a design reflection degree. The design reflection degree is an index indicating how much the designated design elements are reflected in the design of the creation commercial product. In a commercial product generation process to be described later, one or more color schemes, one or more background patterns, one or more logos, and one or more fonts being selection candidates are designated. The target impression is an impression that is required to be eventually given by the commercial product to be created and that is set to be given to a person viewing the created commercial product. In the present embodiment, for each of words or combinations of words representing the impression, a UI operation with the pointing device 107 is performed to designate an intensity indicating how much the commercial product is to give this impression. For example, “premium feel”, “affinity”, “liveliness”, and “substantial feel” are designated as impression factors, respectively. The design element designation component 204 outputs designated design element information to the design element obtaining component 214. Details of impressions are described later

Note that the design element designation component 204 does not have to receive the designation by the user. The designation may be enabled only in the case where the user desires to designate the design elements. Moreover, the design reflection degree does not have to be designated by the user. In the case where the user designates the design elements and the design reflection degree, the user can control the design of the creation commercial product.

The key design designation component 205 receives designation of a key design to be reflected in the creation commercial product. The key design is a design to be a reference of the creation commercial product, and is a design commonly used in multiple creation commercial products. In the case where the key design is a design of a commercial product created in advance, the key design may be the commercial product data created in the commercial product creation application before start of the commercial product generation process, or design data created in another design creation application. An input format of a data file of the key design may be raster data such as JPEG or BMP or vector data in which rendering commands are described. For example, a general page description language (PDL) such as Portable Document Format proposed by Adobe Inc., XPS proposed by Microsoft Corporation, or HP-GL/2 proposed by HP Inc. may be used. One key design may be designated, or multiple key designs may be designated. The key design designation component 205 outputs a file path of the designated key design to the design element obtaining component 214.

Next, a configuration of the commercial product generation component 210 is explained in detail. As a premise, the differences in the type of the creation commercial product can be achieved by selecting types of skeletons corresponding to the creation commercial products in the skeleton obtaining component 213.

The image obtaining component 211 obtains the one or multiple pieces of image data designated by the image designation component 203, from the HDD 104. The image obtaining component 211 outputs the obtained image data to the image analysis component 212. Moreover, the image obtaining component 211 outputs the number of obtained images to the skeleton obtaining component 213. The images saved in the HDD 104 include still images and frame images cut out from a video. The still images and the frame images are images obtained from an imaging device such as a digital camera or a smartphone. The imaging device may be included in the commercial product generation apparatus 100 or may be an external apparatus. Note that, in the case where the imaging device is the external apparatus, the images are obtained via the data communication unit 108. Moreover, as another example, the still images may be illustration images created with image editing software or CG images created with CG creating software. The still images and the cut-out images may be images obtained from a network or a server via the data communication unit 108. The images obtained from the network or the server include social networking service images (hereinafter, referred to as “SNS images”). Moreover, a program executed by the CPU 101 analyzes data attached to each image and determines a saving source for the image. For example, the obtaining destination of the SNS images may be managed in an application by obtaining the images from an SNS via the application. Note that the images are not limited to the images described above, and may be other types of images.

The image analysis component 212 executes an image data analysis process on the image data obtained from the image obtaining component 211, and obtains information indicating image feature amounts. Specifically, the image analysis component 212 executes an object recognition process and a main color extraction process to be described later, and obtains information indicating the image feature amounts of the image data. Moreover, the image analysis component 212 associates the information indicating the image feature amounts obtained from the image data with the image data, and outputs the image data and the information to the layout component 221.

The skeleton obtaining component 213 obtains one or multiple skeletons matching the conditions designated in the creation condition designation component 201, the text designation component 202, the design element obtaining component 214, and the image obtaining component 211, from the HDD 104. In the present embodiment, skeletons are each information indicating arrangement of character strings, images, graphics, and the like to be arranged in the commercial product.

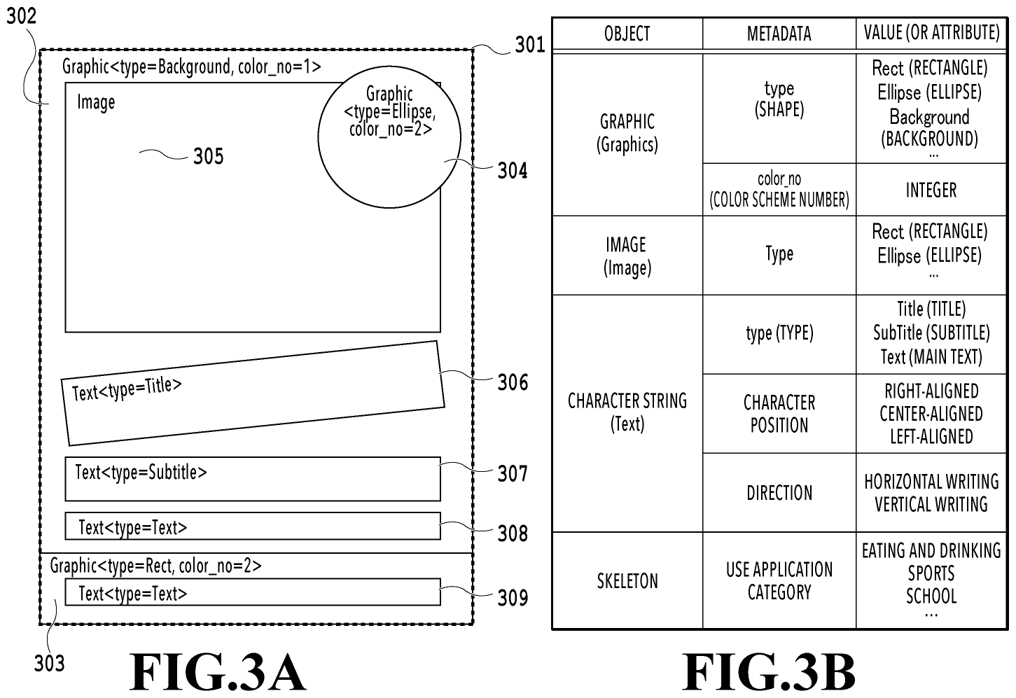

FIGS. 3A and 3B are diagrams illustrating an example of a skeleton for a poster among various commercial products. Three graphical objects 302, 303, and 304, one image object 305, and four text objects 306, 307, 308, and 309 that are objects in which characters are to be arranged are arranged on a skeleton 301 of FIG. 3A. Each object is associated with a position indicating a location where the object is arranged, the size and angle of the object, and metadata necessary for generation of the poster. FIG. 3B is a diagram illustrating an example of the metadata. For example, which type of character information is to be arranged is held in each of the text objects 306 to 309 as an attribute of the metadata. In this example, it is illustrated that a title is to be arranged in the text object 306, a subtitle is to be arranged in the text object 307, and main texts are to be arranged in the text objects 308 and 309. Moreover, a shape of a graphic and a color scheme number (color scheme ID) indicating a color scheme pattern are held in each of the graphical objects 302 to 304 as the attribute of the metadata. In this example, it is illustrated that the attributes of the graphical objects 302 and 303 are rectangle and the attribute of the graphical object 304 is ellipse. Moreover, color scheme number 1 is assumed to be assigned to the graphical object 302, and color scheme number 2 is assumed to be assigned to the graphical objects 303 and 304. In this example, it is illustrated that the color scheme number is information referred to in color scheme arrangement to be described later, and different colors are assigned to different color scheme numbers. Moreover, a graphical object may be rendered by being painted with a uniform color. Furthermore, in each graphical object, a background pattern or a background illustration cut out in a shape of the graphical object may be rendered. Note that the types of objects and the metadata are not limited to those described above. For example, a map object for arranging a map or a barcode object for arranging a QR code (registered trademark) or a barcode may be provided. Moreover, metadata indicating a space between lines and a space between characters may be provided as the metadata of the text object. The configuration may be such that the metadata includes a use application of the skeleton, and the use application is used for control of allowing or not allowing use of the skeleton depending on use application.

The skeletons may be managed while being categorized depending on the type of commercial product. For example, there are skeletons for a poster, skeletons for a menu, skeletons for a postcard, skeletons for a threefold leaflet, skeletons for a calendar, skeletons for a banner, and the like. Moreover, the skeletons may be managed in groups each formed of multiple skeletons categorized based on relationships such as arrangement of objects and the like. For example, the configuration may be such that a group including skeletons configured to give premium feel is created as skeleton group 1, and the same skeleton group ID is held in the pieces of metadata of the respective skeletons in this group. Based on a skeleton group ID of a skeleton used in creation of one commercial product, the commercial product creation application can thereby determine skeletons to be applied to the other types of commercial products. As a result, it is possible to achieve a uniform design among multiple commercial products in the case where data of multiple commercial products is created.

Moreover, the skeletons may be managed while being categorized depending on a ratio of width and height. The commercial product creation application can thereby obtain a skeleton with a ratio of width and height matching the size of the commercial product designated in the creation condition designation component 201.

For example, the skeleton may be saved in the HDD 104 in a CSV format or in a DB format such as SQL. The skeleton obtaining component 213 outputs the one or multiple skeletons obtained from the HDD 104, to the skeleton selection component 216.

The design element obtaining component 214 obtains design elements to be used in design generation, from the key design designated in the key design designation component 205. The design element obtaining component 214 extracts the color scheme, the background pattern, the logo, the font, and the impression value, as the design elements from the file of the key design designated in the key design designation component 205. The extracted impression value is used as a target impression of the creation commercial product.

In the case where the impression value is extracted from the key design, the design element obtaining component 214 estimates the impression of the commercial product data that is the key design, by performing an impression estimation process to be described later. Alternatively, in the case where the key design is the commercial product data previously created in the commercial product creation application, the impression estimated from the commercial product data in the creation is held in association with the commercial product data, and the design element obtaining component 214 obtains the impression value of this impression. An extraction method of other design elements is described later.

Moreover, the design element obtaining component 214 obtains the design elements based on design element information designated by the user in the design element designation component 204, and mixes (hereinafter, referred to as “merges”) the design elements with the design elements obtained from the key design. Specifically, the design element obtaining component 214 merges each of the design elements extracted from the file of the commercial product data designated as the key design and a corresponding one of the design elements designated in the design element designation component 204 with each other. Note that the configuration may be such that no merging is performed for a design element that is not designated by the user or in the case where designation of the design element is set to disabled, and only the design element extracted from the key design is used in the creation commercial product.

As an example, in the case where the target impressions are merged, the design element obtaining component 214 sets, for example, an average value of the impression value extracted from the key design and the impression value of the target impression designated in the design element designation component 204 for each impression factor, as a target impression value after the merging. Moreover, instead of the average value, a representative value of multiple values such as the maximum value and the minimum value may be set as the target impression value after the merging.

In the case where the design reflection degree is designated by the user in the design element designation component 204, the design element obtaining component 214 merges the design element extracted from the key design and the design element designated by the user, depending on the design reflection degree. This can more correctly reflect the intention of the user. Specifically, elements of each type of design element are merged by using the following formula (1). Note that the formula (1) describes a formula for the target impression. In the formula (1), the value of the design reflection degree is converted to a value in a range of 0 to 1. A designated target impression value is the target impression received from the user in the design element designation component 204. An extracted target impression value is the impression value extracted from the key design.

Target impression value after merging=reflection degree×designated target impression value+(1−reflection degree)×extracted target impression value (1)

Moreover, the design element obtaining component 214 creates a color scheme list in which the color scheme extracted from the key design and the color scheme designated in the design element designation component 204 are merged, and outputs the color scheme list to the color scheme pattern obtaining component 215. The design element obtaining component 214 creates a logo list in which the logo extracted from the key design and the logo designated in the design element designation component 204 are merged, and outputs the logo list to the logo selection component 219. The design element obtaining component 214 creates a font list in which the font extracted from the key design and the font designated in the design element designation component 204 are merged, and outputs the font list to the font selection component 220. Note that, in these lists, the color scheme, the logo, and the font designated in the design element designation component 204 and the color scheme, the logo, and the font extracted from the key design are held in a form in which the color schemes, the logos, and the fonts are distinguishable from one another.

The design element obtaining component 214 outputs the logo list to the skeleton obtaining component 213. The design element obtaining component 214 outputs the merged target impression value and the reflection degree designated in the design element designation component 204 to the skeleton selection component 216, the color scheme pattern selection component 217, the background pattern scaling component 218, the logo selection component 219, the font selection component 220, and the commercial product selection component 223.

Moreover, regarding the background pattern, in the case where the background pattern is designated in the design element designation component 204, the design element obtaining component 214 outputs the designated background pattern to the background pattern scaling component 218. In the case where no background pattern is designated in the design element designation component 204, the design element obtaining component 214 outputs the background pattern extracted from the key design to the background pattern scaling component 218. For example, in the case where the file designated as the key design is raster data, accurate extraction of the entire background pattern of the key design is difficult in some cases. In this case, the user designates SVG data or raster data being the source of the background pattern of the key design, as the background pattern in the design element designation component 204. The design element obtaining component 214 can thereby obtain an accurate background pattern.

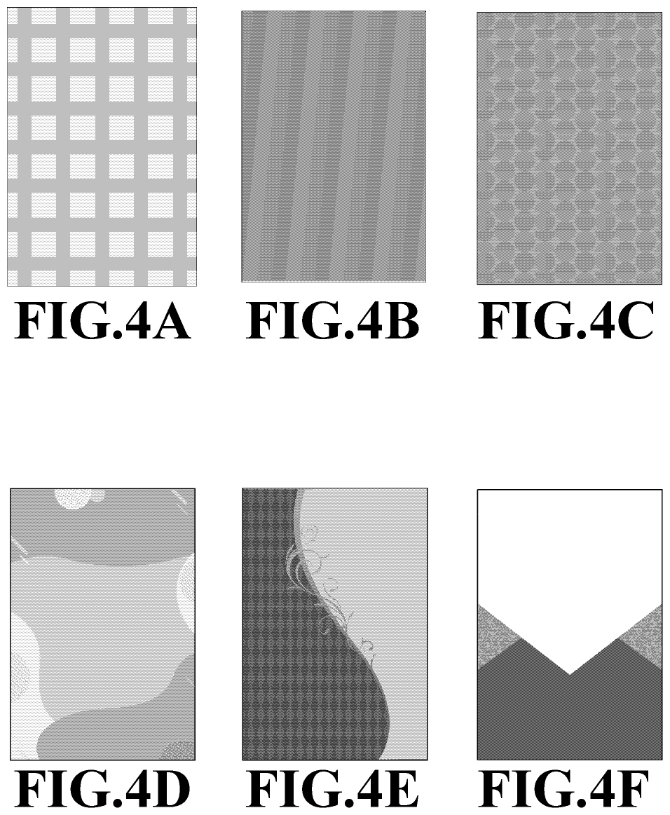

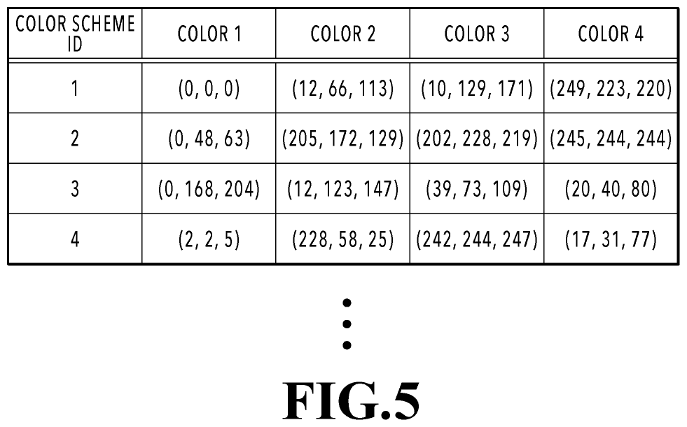

FIGS. 4A to 4F are diagrams illustrating examples of the background pattern. FIGS. 4A, 4B, and 4C illustrate background patterns that are repeated patterns. FIGS. 4D, 4E, and 4F each illustrate a case where the background pattern is a figure or partially includes a repeated pattern. As described above, the background pattern in the present embodiment refers to a pattern that is used as a background of a design and that includes a certain figure.

The color scheme pattern obtaining component 215 obtains a main color list of the image from the image analysis component 212, and obtains the color scheme list from the design element obtaining component 214. Moreover, in the case where an additional color number is designated in the creation condition designation component 201, the color scheme pattern obtaining component 215 obtains the designated additional color number. Furthermore, the color scheme pattern obtaining component 215 obtains the color scheme pattern depending on the obtained main color list of the image, the obtained color scheme list, and the obtained additional color number. The color scheme pattern is a combination of colors to be used in the commercial product. Moreover, in the case where a color is designated in the creation condition designation component 201, the color scheme pattern obtaining component 215 also obtains a color scheme pattern including this designated color from the HDD 104, and outputs the obtained color scheme pattern to the color scheme pattern selection component 217.

FIG. 5 is a diagram illustrating an example of a table illustrating the color scheme patterns. In the present embodiment, each color scheme pattern is illustrated as a combination of four colors. The column of color scheme ID in FIG. 5 includes an ID for uniquely identifying the color scheme pattern. Columns of color 1 to color 4 each store a value of a color. In the value of the color, a color value of each of R, G, and B is expressed in a value of 0 to 255 in the order of RGB ((R, G, B)=(0 to 255, 0 to 255, 0 to 255)). Although the color scheme pattern formed of the combination of four colors is used in the present embodiment, the number of colors may be another number, or multiple numbers of colors may coexist.

The skeleton selection component 216 selects a skeleton that matches the type of commercial product designated in the creation condition designation component 201 and that matches the target impression merged in the design element obtaining component 214, from among the skeletons obtained from the skeleton obtaining component 213. The skeleton selection component 216 outputs the selected skeleton to the layout component 221. The selected skeleton satisfies the following conditions. Specifically, the selection is performed such that one or multiple skeletons are selected for one type of commercial product, and one or multiple skeletons matching the target impression are selected for each type of commercial product. Since arrangement of each commercial product as a whole is determined by the skeleton, preparing various types of skeletons in advance can increase variations of each commercial product after the generation.

The color scheme pattern selection component 217 selects one or multiple color scheme patterns matching the target impression merged in the design element obtaining component 214 from among the color scheme patterns obtained in the color scheme pattern obtaining component 215, and outputs the selected one or multiple color scheme patterns to the layout component 221.

The background pattern scaling component 218 scales the background pattern obtained by the design element obtaining component 214 by a scaling ratio that varies depending on the size or the type of the creation commercial product designated in the creation condition designation component 201. In the following explanation, enlarging or reducing the size is referred to as scaling. The background pattern scaling component 218 determines a size ratio R between the background pattern (background information) of the key design (first creation product data) that is the source and the background pattern (background information) of the creation commercial product (second creation product data) that is the destination. Then, the background pattern scaling component 218 enlarges or reduces the background pattern (background information) of the key design (first creation product data) by the determined size ratio R, and generates the background pattern (background information) of the creation commercial product. The background pattern scaling component 218 determines the size ratio R of the background pattern such that the size ratio R takes a value between 1 and a ratio C₁₂ between the size C₁ of the key design and the size C₂ of the creation commercial product. The size ratio between the background pattern of the key design and the background pattern of the creation commercial product being the destination is also referred to as scaling ratio R in the following explanation. The scaling ratio R is expressed by the following relationship formula (2).

$$R = α {C}_{12} \{ \begin{matrix}1 < α < \frac{1}{{C}_{12}} & if 1 < \frac{1}{{C}_{12}} \\ \frac{1}{{C}_{12}} < α < 1 & otherwise\end{matrix} \qquad ( 2 )$$

$$where {C}_{12} = \frac{{C}_{2}}{{C}_{1}} .$$

C₁ is the length of the diagonal line of the first creation product data that is the source, and C₂ is the length of the diagonal line of the second creation product data that is the destination. Note that C₁₂ is not limited to the ratio between the lengths of the diagonal lines, and may be any value indicating a ratio between the size of the first creation product data and the size of the second creation product data such as an area ratio, square root of the area ratio, a ratio between lengths of corresponding sides of the first creation product data and the second creation product data, and the like.

In this formula, α is a coefficient for determining the scaling ratio R, and the following determination method of α is conceivable. Specifically, the coefficient α is determined based on a ratio between a distance at which the first creation product data is viewed and a distance at which the second creation product data is viewed. The following formula (3) is a formula for determining the coefficient α.

$$α = \frac{{D}_{1}}{{D}_{2}} \qquad ( 3 )$$

In this formula, D₁ is an expected viewing distance of the first creation product data that is the source, and D₂ is an expected viewing distance of the second creation product data that is the destination. The viewing distance is a distance between the commercial product and a person viewing the commercial product. For example, posters are viewed from a long distance, and business cards are viewed from a distance of one's hand in many cases. An object whose viewing distance is large, that is located far away appears small in inverse proportion to the viewing distance. The expected viewing distance is a distance at which viewing is expected, and is set in advance for each commercial product, or is designated by the user.

Alternatively, the coefficient α is determined based on a ratio between a font size of a representative text used in the first creation product data and a font size of a representative text used in the second creation product data. In this case, the coefficient α is determined based on the following formula (4). F₁ in the formula (4) is the size of the representative text in the first creation product data that is the source, and F₂ is the size of the representative text in the second creation product data that is the destination. The representative text may be a text whose attribute is designated to be the title or a text with the largest font size in the commercial product.

$$α = \frac{{F}_{1}}{{F}_{2}} \qquad ( 4 )$$

Alternatively, the coefficient α may be determined such that the impression of the commercial product becomes closer to the impression of the key design. In this case, the background pattern scaling component 218 scales the background pattern while changing the value of α to various values, creates commercial products in which the scaled background patterns are laid out by a layout process to be described later, and estimates the impressions of the completed commercial product images. The background pattern scaling component 218 uses α at which this estimated impression value is close to the impression value of the key design, for the determination of the scaling ratio R. Note that, as described above, the value of α is set to a value in a range of 1<α<1/C₁₂ in the case of 1<1/C₁₂, and is set to a value in a range of 1/C₁₂<α<1 in the case of 1/C₁₂<1. Moreover, the smaller the impression distance between the estimated impression value and the impression value of the key design is, the closer the impressions are to each other. For example, in the case where one value of α is to be determined, α at which the impression distance is the smallest is selected. In the case where multiple values of a are to be determined, N values of a are selected in ascending order of the impression distance.

The background pattern scaling component 218 outputs the enlarged or reduced background pattern to the layout component 221 in association with the size or the type of the creation commercial product.

Note that the determination method of the coefficient α is not limited to the above-mentioned methods, the coefficient α may be any value as long as the scaling ratio is determined to be a value between 1 and the ratio between the size of the first creation product data and the size of the second creation product data. The scaling of the background pattern is described later.

The logo selection component 219 selects one or multiple logos matching the target impression merged in the design element obtaining component 214, from the logo list of the logos merged by the design element obtaining component 214, and outputs the one or multiple logos to the layout component 221.

The font selection component 220 selects one or multiple font patterns matching the target impression merged in the design element obtaining component 214, from among the fonts merged in the design element obtaining component 214, and outputs the one or multiple font patterns to the layout component 221. The font pattern is a font combination including at least two fonts selected from a font of the title, a font of the subtitle, and a font of the main text.

The layout component 221 combines and lays out various pieces of data on each of the one or multiple skeletons obtained from the skeleton selection component 216. Pieces of commercial product data as many as or more than a predetermined creation number are thereby created for the one or multiple types of commercial product data designated in the creation condition designation component 201. The creation number may be a value designated by the user in the creation condition designation component 201, or may be a value set in advance.

The layout component 221 arranges the text obtained from the text designation component 202 and the image data obtained from the image analysis component 212, on each of the skeletons. Then, the layout component 221 applies the color scheme pattern obtained from the color scheme pattern selection component 217, and applies the font pattern selected in the font selection component 220. Furthermore, the layout component 221 arranges the background pattern obtained from the background pattern scaling component 218 and scaled depending on the size or the type of the creation commercial product in a background region of each skeleton. For example, the background region is set in the skeleton as a graphical object. Moreover, the layout component 221 arranges the logo selected in the logo selection component 219 in a logo region of each skeleton. The logo region is set in the skeleton as a graphical object or a text object. The layout component 221 outputs one or multiple pieces of generated commercial product data, to the impression estimation component 222.

The impression estimation component 222 estimates the impression of each of the commercial product images obtained by rendering the multiple pieces of commercial product data obtained from the layout component 221, and associates the estimated impression (estimated impression) with the corresponding piece of commercial product data. Then, the impression estimation component 222 outputs the one or multiple pieces of commercial product data associated with the estimated impressions, to the commercial product selection component 223.

The commercial product selection component 223 selects the commercial product to be displayed on the display 105 as a creation result, based on a result of comparison between the target impression merged in the design element obtaining component 214 and the estimation results of the multiple pieces of commercial product data associated with the estimated impressions obtained from the impression estimation component 222. The selected commercial product is saved in the HDD 104. The commercial product selection component 223 outputs the selected commercial product data to the generated commercial product display component 206.

The commercial product selection component 223 selects a creation commercial product in which a distance (impression distance) between the target impression and the estimated impression associated with created commercial product data is smaller than a predetermined threshold. Moreover, in the case where the creation commercial product is a commercial product set including multiple commercial products varying in type, the commercial product selection component 223 selects a commercial product set in which a total of distances (total impression distance) between the target impression and the estimated impressions associated with multiple pieces of commercial product data varying in type is smaller than a predetermined threshold. A value indicating each impression is expressed as a vector, and the distance is expressed as an inter-vector distance. Specifically, the smaller the distance between the target impression and the impression estimated from the creation commercial product is, the closer the creation commercial product is to the target impression.

The generated commercial product display component 206 renders the commercial product data obtained from the commercial product selection component 223, and outputs the commercial product image to be displayed on the display 105. The commercial product image is, for example, bit map data. The generated commercial product display component 206 displays the commercial product image on the display 105.

Note that the commercial product creation application may be have a function of further changing the design of the commercial product to a design desired by the user after the display of the generation result in the generated commercial product display component 206, by editing the arrangement, the colors, the shapes, and the like of the image, the text, and the graphic by additional user operations (not illustrated).

Moreover, providing a function of printing the commercial product data saved in the HDD 104 with a printer under a condition designated in the creation condition designation component 201 allows the user to obtain a print product of the created commercial product.

### <Example of Display Screen>

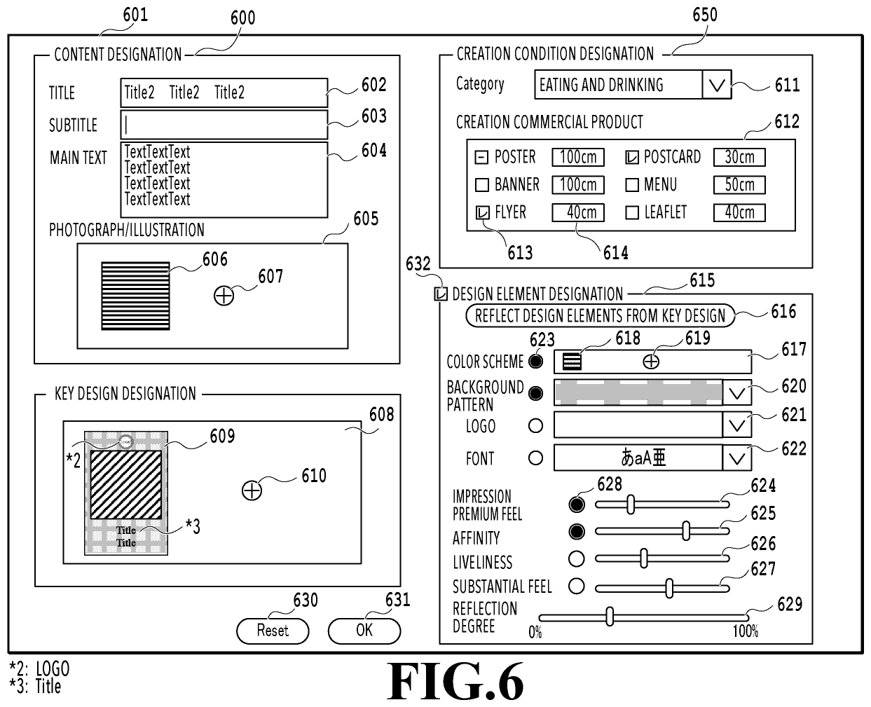

FIG. 6 is a diagram illustrating an example of an application launch screen 601 provided by the commercial product creation application. The application launch screen 601 is displayed on the display 105. The user performs the designation of the key design, the designation of the creation conditions of the commercial product, the designation of the contents (texts and images), and the designation of the design elements through the application launch screen 601. The creation condition designation component 201, the image designation component 203, the text designation component 202, the design element designation component 204, and the key design designation component 205 obtains the designation contents from the user through this UI screen.

A content designation region 600 includes a title box 602, a subtitle box 603, a main text box 604, and an image designation region 605. The title box 602, the subtitle box 603, and the main text box 604 receive designation of character information to be arranged in the commercial product. Although three types of character information are received in the present embodiment, the present disclosure is not limited to this. For example, character information such as location, time, and date may be additionally received. Moreover, the character information does not have to be designated for all boxes, and thereby may be a blank box. The configuration may be such that display and display contents of the boxes are changed depending on a designation result in a creation commercial product designation region 612. For example, in a case where the poster is selected, the boxes for designating the title, the subtitle, and the main text are displayed. In the case where the postcard is selected, boxes for designating the title, an address, and a contact are displayed. In the case where multiple commercial products are selected in the creation commercial product designation region 612, a type of box that overlap between the multiple commercial products may receive designation of separate pieces of character information, or receive designation of one piece of character information in a batch. Moreover, the configuration may be such that the display and the display contents of the boxes are changed depending on a designation result of a category designation region 611. For example, in the case where eating and drinking is selected, the boxes for designating the address and the contact are displayed. Meanwhile, in the case where event is selected, boxes for designating venue, time, and date are displayed. The text designation component 202 obtains the designation information of the texts from the user through these UI screens.

The image designation region 605 is an UI that receives designation of an image to be arranged in the commercial product. A thumbnail 606 of the designated image is displayed in the image designation region 605. An image addition button 607 is a button operated in the case where an image to be arranged in the commercial product is to be added. In the case where the user presses the image addition button 607, the image designation component 203 displays a dialog screen for selecting an image file from the HDD 104 or via a network, and receives image file selection by the user on the dialog screen. Then, a thumbnail of the selected image is added to the image designation region 605. In the case where multiple commercial products are selected in the creation commercial product designation region 612, the image designation region 605 may receive designation of an image individually for each type of commercial product, or receive designation of an image to be commonly used in the multiple commercial products simultaneously. The image designation component 203 obtains designation information of the image from the user through this UI screen.

A key design designation region 608 is a UI that receives designation of a key design to be used in commercial product creation. In the key design designation region 608, a thumbnail 609 of the designated key design is displayed. A key design addition button 610 is a button operated in the case where a key design to be arranged in the commercial product is to be added. In the case where the user presses the key design addition button 610, the key design designation component 205 displays a dialog screen for selecting a file saved in the HDD 104, and receives key design file selection by the user on the dialog screen. Then, a thumbnail of the selected key design is added to the key design designation region 608. The key design designation component 205 obtains designation information of the key design from the user through this UI screen.

A creation condition designation region 650 includes the category designation region 611 and the creation commercial product designation region 612.

The category designation region 611 is a UI that receives designation of a use application category of the commercial product to be created. For example, the category designation region 611 includes a list box that displays a list of selectable use application categories. The category designation region 611 does not have to be provided. However, providing the category designation region 611 allows the user to control generation of the commercial product matching the category.

The creation commercial product designation region 612 is a UI that receives designation of the type of the commercial product to be created. For example, the creation commercial product designation region 612 includes a check box 613 and a distance box 614 for each type of commercial product, and receives designation for one or multiple types of creation commercial products. A check state of each check box 613 can be switched by a click operation performed by the user with the pointing device 107. There are three types of check states in the check box 613, and “v” indicates a state where the corresponding type is designated as the commercial product to be created, “-” indicates a state where the corresponding type is designated as the key design, and blank indicates a disabled state.

The distance box 614 receives input of the expected viewing distance by the user. In the case where the commercial product is designated as the key design, the expected viewing distance of the key design is designated. In the case where the commercial product is designated as the creation commercial product, the expected viewing distance of the creation commercial product is designated. Note that an initial value determined in advance for each type of commercial product and each size of commercial product may be displayed in the distance box 614. The initial value is a value of the viewing distance set in advance in a development stage of the commercial product creation application by a developer of the commercial product creation application. Moreover, the configuration may be such that the expected viewing distances are held in the application, and the creation condition designation component 201 of the commercial product creation application obtains the expected viewing distance corresponding to the commercial product or the key design designated in the check box 613. In this case, the user input for the distance box 614 is unnecessary, and the distance box 614 does not have to be displayed. Moreover, the designation of the key design may be received in the key design designation region 608, instead of the creation commercial product designation region 612.

A design element designation region 615 is a UI that receives designation of a design element by the user for each design element. The design element designation region 615 includes a color scheme designation box 617, a background pattern designation box 620, a logo designation box 621, a font designation box 622, impression sliders 624 to 627, and a reflection degree slider 629.

The color scheme designation box 617 is an UI for inputting information on a color to be used in the commercial product generation. A color 618 illustrates a thumbnail of a designated color. A color addition button 619 is a button for adding designation of a color. In the case where the color addition button 619 is pressed, a list illustrating multiple colors in a selectable manner is displayed, and in the case where one of the colors is selected from this list by an operation performed with the pointing device 107, the selected color is added. Moreover, for example, a UI for designating a color such as a color pallet in which multiple colors are arranged may be displayed.

The background pattern designation box 620 is a UI for inputting information on a background pattern to be used in the commercial product generation. In the present embodiment, a list of multiple background patterns is displayed, and designation of a background pattern is received by a click operation performed with the pointing device 107. Moreover, a background pattern may be designated such that a dialog screen (not illustrated) that displays files in which background patterns are saved is displayed, and a file is selected by a click operation performed with the pointing device 107. The format of the files may be an image file format (JPEG, bitmap, or the like) or a vector data format (PDF).

The logo designation box 621 is a UI for inputting information on a logo to be used in the commercial product generation. In the present embodiment, a list of multiple logos is displayed, and designation of a logo is received by a click operation performed with the pointing device 107. Moreover, a logo may be designated such that a dialog screen (not illustrated) that displays files in which logos are saved is displayed, and a file is selected by a click operation performed with the pointing device 107. The format of the files may be an image file format (JPEG, bitmap, or the like) or a vector data format (PDF).

The font designation box 622 is an UI for inputting information on a font to be used in the commercial product generation. In the present embodiment, a list of multiple fonts is displayed, and designation of a font is received by a click operation performed with the pointing device 107. Moreover, a font may be designated such that a dialog screen (not illustrated) that displays files in which fonts are saved is displayed, and a file is selected by a click operation performed with the pointing device 107.

Each of radio buttons 623 is a button for controlling enabling and disabling of a setting of a corresponding one of the design elements. The user presses the radio button 623 to set on/off, and can thereby set whether to enable or disable the setting of the corresponding design element information. FIG. 6 illustrates a state in which the color scheme and the background pattern are enabled.

The impression sliders 624 to 627 are a UI for designating the target impression for the commercial products to be created. In the present embodiment, the target impression includes four impression factors of premium feel, affinity, liveliness, and substantial feel. For example, the impression slider 624 is an operation object for setting a value of an impression factor relating to premium feel. The target impression is set such that further the impression slider 624 is slid to the right, the higher the premium feel given by the commercial product is, and the further the impression slider 624 is slid to the left, the lower (cheaper) the premium feel given by the commercial product is. Moreover, combining the factors of the target impression set in the respective sliders achieves settings of a target impression reflecting not only the factor of the target impression set in one slider but also the factors of the target impression set in the other sliders.

For example, assume a where the user sets the impression slider 624 for controlling the “premium feel” on the right side of the center of the slider and sets the impression slider 627 for controlling the “substantial feel” on the left side of the center of the slider. In this case, an elegant impression that has high premium feel and low substantial feel is set as the target impression, and the commercial product creation application generates commercial products with an elegant impression. Moreover, for example, in the case where the impression slider 624 for controlling the “premium feel” is set on the right side of the center of the slider and the impression slider 627 for controlling the “substantial feel” is set on the right side of the center of the slider, a gorgeous target impression that has high premium feel and high substantial feel is set. In this case, the commercial product creation application generates commercial products with a gorgeous impression.

Combining multiple impression factors as described above enables setting of target impressions of various directions such as the “elegant” impression and the “gorgeous” impression even in the case where a common impression factor of presence of “premium feel” is set. Specifically, the target impression is formed of and determined by multiple factors indicating the impression. However, the present disclosure is not limited to this, and the target impression may be determined by one factor indicating the impression. In the present embodiment, the value indicating each impression factor is assumed to be expressed by an integral value from −2 to +2 with −2 being a state where the slider set to the left-most position and +2 being a state where the slider is set to the right-most position. These numerical values are values indicating a degree of the corresponding impression factor, and indicates that −2 is low, −1 is slightly low, 0 is neither high nor low, +1 is slightly high, and +2 is high. Note that a purpose of expressing the degree of the impression factor while correcting the degree to the numerical range of −2 to +2 is to match the degree with a scale of the estimated impression to be described later and facilitate distance calculation to be described later. Accordingly, the value of the impression factor is not limited the numerical range of −2 to +2, and normalization may be performed by using a value from 0 to 1.

Radio buttons 628 are buttons for controlling enabling or disabling of settings of the respective impression factors. The user can set whether to enable or disable the setting of each impression factor by pressing a corresponding one of the radio buttons 628 and setting on/off. For example, in the case where off is selected in one of the radio buttons 628, the corresponding impression factor is excluded from the control target of the target impression. For example, a user who desires to create a calm commercial product with low liveliness and who desires no particular designation for other impressions can set the radio buttons 628 for the impression factors other than the liveliness to off to generate a commercial product specialized in low liveliness. Note that FIG. 6 illustrates a state where premium feel and affinity are enabled, and liveliness and substantial feel are disabled. The radio buttons 628 enable impression control with high flexibility, for example, impression control in which a target impression including all impression factors or a target impression including only some of the impression factors is designated.

Note that the configuration may be such that, in the case where each of the impression sliders 624 to 627 is set to the left-most position, this state is assumed to be the same as a state in which the corresponding impression factor is not set, and the on/off operation of the corresponding radio button 628 is not received. For example, this is such that, in the case where the impression slider 624 is set to the left-most position, the premium feel is set to 0. In this configuration, in the case where there is an impression factor whose setting is desired to be disabled, the user can disable the setting by setting the corresponding slider to the left-most position.

The reflection degree slider 629 is a UI for setting a weight at which each piece of design element information set in the design element designation region 615 is reflected in the commercial product generation. In the case where the reflection degree slider 629 is set to the left-most position, the weight is set to 0%, and the inputted design element information is ignored and is not reflected in the commercial products. In the case where the reflection degree slider 629 is set to the right-most position, the weight is set to 100%, and the inputted design element information is always reflected in the commercial products. For example, in the case where the reflection degree slider 629 is set at a position of 40% as illustrated in FIG. 6, the reflection degree of the design elements is 40%. The design element obtaining component 214 sets the skeleton selection component 216, the color scheme pattern selection component 217, the logo selection component 219, and the font selection component 220 such that a usage frequency or a usage probability of each of the design elements designated in the design element designation region 615 is 40%.

Note that the design element designation region 615 may be provided with a check box 632 for enabling settings in the design element designation region 615. The configuration may be such that, in the case where the user desires to individually designate the design elements, the designation of each design element is made possible by inputting a check mark in the check box 632 and enabling the settings. In the case where no check mark is inputted in the check box 632 and the settings in the design element designation region 615 are disabled, the settings are the same as those in the state where the above-mentioned reflection degree is set to 0%.

The design elements extracted from the key design set in the key design designation region 608 may be reflected and set in the UI of the design element designation region 615 for the respective design elements. In the case where a key design reflection button 616 is pressed, the design element obtaining component 214 obtains the key design from the key design designation component 205, and extracts the design elements. The extracted design elements are shared with the design element designation component 204, and are reflected in the design element designation region 615. Reflecting the design elements of the key design allows the user to set only a missing element or an element desired to be changed while referring to the design elements of the key design, and the designation of the design elements is facilitated. Note that the design elements that can be designated in the design element designation region 615 illustrated in FIG. 6 are examples, and other items relating to design can be designated as the design elements.

A reset button 630 is a button for resetting the pieces of setting information on the application launch screen 601. In the case where the user presses an OK button 631, the creation condition designation component 201, the text designation component 202, the image designation component 203, the design element designation component 204, and the key design designation component 205 output the information set on the application launch screen 601 to the commercial product generation component 210. The creation condition designation component 201 obtains the type and the expected viewing distance of each of the commercial products to be created from the creation commercial product designation region 612, and obtains the use application category of the commercial products to be created from the category designation region 611. The design element designation component 204 obtains the color from the color scheme designation box 617, obtains the background pattern from the background pattern designation box 620, obtains the logo from the logo designation box 621, and obtains the font from the font designation box 622. The design element designation component 204 further obtains the information on whether the design element information is enabled or not from the check box 632, and obtains the target impression of the commercial products to be created from the impression sliders 624 to 627 and the radio buttons 623. The design element designation component 204 further obtains the reflection degree of the design element information from the reflection degree slider 629.

The text designation component 202 obtains the character information to be arranged in the commercial products from the title box 602, the subtitle box 603, and the main text box 604. The image designation component 203 obtains a file path of the image to be arranged in the commercial products from the image designation region 605. The key design designation component 205 obtains a file path of the key design from the key design designation region 608.

Note that the creation condition designation component 201, the text designation component 202, the image designation component 203, the design element designation component 204, and the key design designation component 205 may process the values set in the application launch screen 601. For example, the text designation component 202 may perform a process of removing unnecessary whitespace characters at a head or an end of the inputted character information, from the inputted character information. Moreover, the design element designation component 204 may correct the values of the target impression designated in the impression sliders 624 to 627.

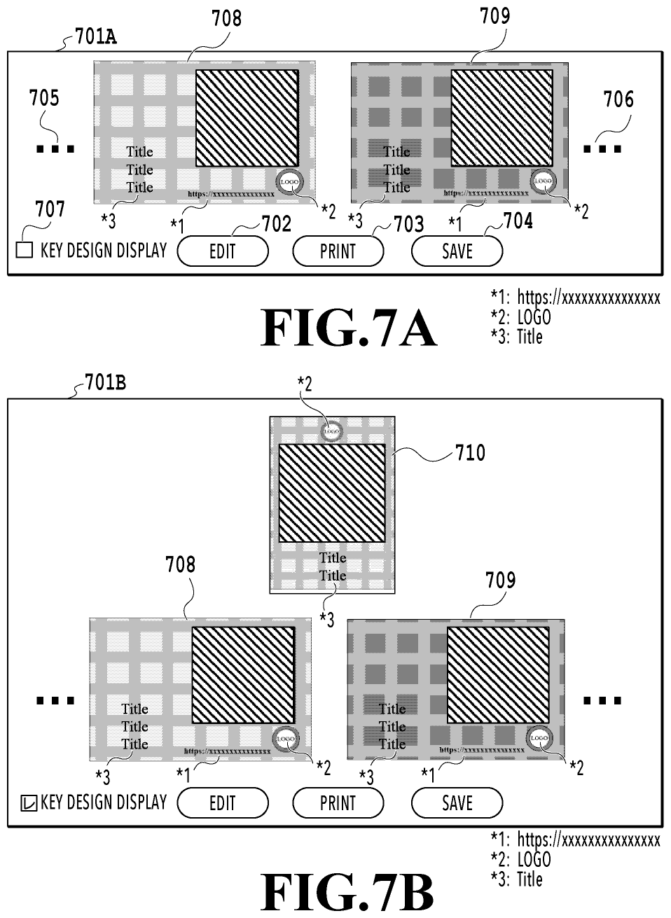

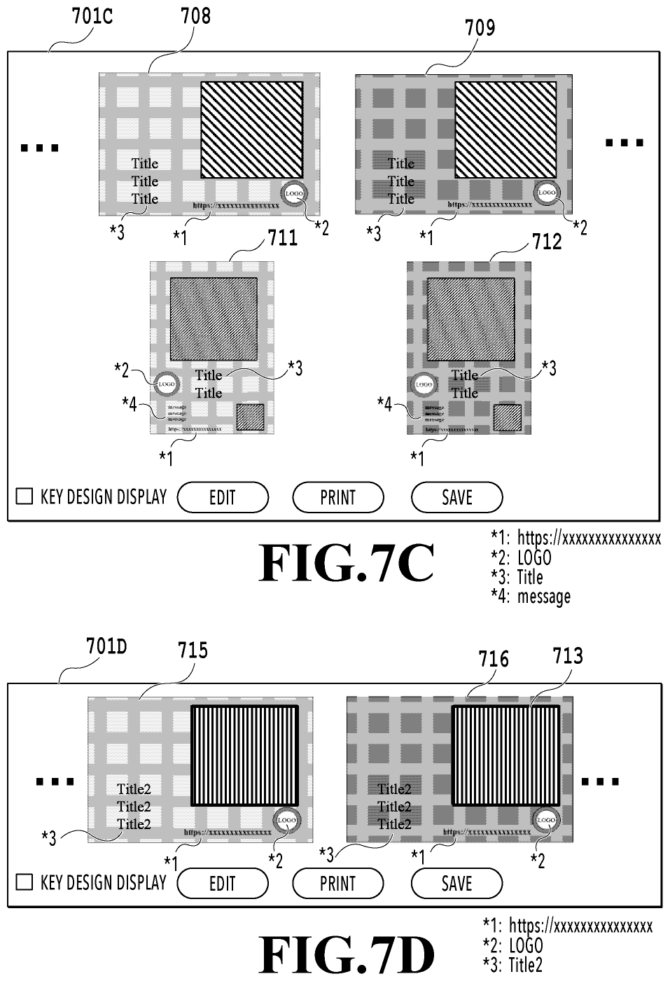

FIGS. 7A to 7D are diagrams illustrating an example of a preview screen 701. The preview screen 701 is a screen in which images of the commercial products generated by the commercial product generation component 210 are displayed, and is displayed on the display 105 by the generated commercial product display component 206.

FIGS. 7A to 7D illustrate, respectively, examples of preview screens 701A, 701B, 701C and 701D that vary in display contents. FIGS. 7A to 7D illustrate that the contents displayed on the preview screen 701 vary depending on the information designated by the user in the application launch screen 601. In the following explanation, the preview screens 701A, 701B, 701C and 701D are referred to as preview screen 701 in the case where the preview screens 701A, 701B, 701C and 701D are not distinguished from one another. In the case where the OK button 631 on the application launch screen 601 is pressed and the generation of the commercial products by the commercial product generation component 210 is completed, the screen displayed on the display 105 transitions to the preview screen 701. Since multiple commercial products are generated by the commercial product generation component 210, multiple commercial product images are displayed as a list on the preview screen 701. The user clicks one of the commercial products from the list of the commercial product images with the pointing device 107, and the clicked commercial product is thereby set to a selected state. Multiple commercial products may be selectable.

An edit button 702 is a button operated in the case of transition to a not-illustrated edit function. In the case where the edit button 702 is pressed, the screen transitions to a UI that provides the edit function, and the commercial product set to the selected state is made editable. A print button 703 is a button operated in the case of transition to a control UI of a not-illustrated printer. In the case where the print button 703 is pressed, the commercial product set to the selected state can be printed through the control UI. A save button 704 is a button operated in the case where the commercial product set to the selected state is saved. Pressing of the save button 704 allows the commercial product set to the selected state to be saved in the HDD 104 in a predetermined re-editable format. The predetermined format is CSV format, JSON format, or the like. The saved information includes the estimated impression and the design elements (logo, background pattern, color scheme, and font) of the commercial product.

A next candidate display button 706 is a button for displaying, in the screen, the generated commercial product images that cannot be displayed in the preview screen 701. In the preview screen 701, the number of commercial product images that can be displayed in the screen is determined in advance depending on the screen size. In the case where the number of commercial products generated by the commercial product generation component 210 is larger than the number of commercial product images that can be displayed in the screen, the next candidate display button 706 is enabled. In the case where the next candidate display button 706 is pressed, not-displayed commercial product images are displayed in the screen, and the commercial product images that have been displayed are hidden from the screen. The commercial product images may be hidden one by one, or multiple images may be hidden together. The number of commercial product images that are hidden may be designated by the user in a not-illustrated designation region. A previous candidate display button 705 is a button for re-displaying the commercial product images hidden from the screen by the operation of the next candidate display button 706. The previous candidate display button 705 is enabled in the case where the next candidate display button 706 is pressed. In the case where the previous candidate display button 705 is pressed, the commercial product images displayed before the pressing of the next candidate display button 706 are displayed, and the commercial product images displayed in the case where the next candidate display button 706 is pressed are hidden.

A check box 707 is a check box for switching whether the key design designated in the key design designation component 205 is to be displayed on the preview screen 701 or not. In the case where a check is inputted in the check box 707, the display of the key design is enabled.

Differences in display contents of FIGS. 7A to 7D are explained in detail together with the designation information designated by the user on the application launch screen 601.

The preview screen 701A illustrated in FIG. 7A illustrates a state of one-commercial product display. The preview screen 701A is displayed in the following case. On the application launch screen 601, one type of creation commercial product is designated, one key design is designated, no designation of contents is inputted, and no designation of design elements is inputted. Commercial product images 708 and 709 displayed on the preview screen 701A are commercial product images generated by using the design elements extracted from the key design designated in the key design designation region 608. Two patterns of commercial product images are displayed on this screen, and operation of the next candidate display button 706 or the previous candidate display button 705 causes the commercial product images of other patterns to be displayed in the screen. The two commercial product images 708 and 709 are illustrated to vary only in the background color with the key design maintained. In the case where the designation information as described above is designated in the items of the application launch screen 601, there are generated variations of designs similar to the key design in which the background color is changed while the key design is maintained.

The preview screen 701B illustrated in FIG. 7B illustrates a state of key design display. In comparison to the preview screen 701A of FIG. 7A, the check box 707 is set to enabled, and a key design image 710 is displayed. The designation information in the application launch screen 601 is the same as that in FIG. 7A. Displaying the key design image 710 and the commercial product images 708 and 709 generated by the commercial product generation component 210 side by side in the screen as in the preview screen 701B facilitates comparison of the key design and the commercial product images generated by the commercial product generation component 210. Note that, in the example of FIG. 7B, the key design image 710 and the commercial product images 708 and 709 are each displayed while being enlarged or reduced such that these images can be displayed in a preview region of the preview screen 701 having a predetermined size. However, the present disclosure is not limited to this, and the commercial products may be displayed in ratios of actual commercial product sizes.

The preview screen 701C illustrated in FIG. 7C illustrates a state of multiple-commercial product display. In comparison to FIG. 7A, FIG. 7C illustrates the preview screen 701C in the case where multiple types of commercial products are selected. In comparison to the preview screen 701A of FIG. 7A, commercial product images 711 and 712 whose type is different from the type of the commercial product images 708 and 709 are additionally displayed. The designation information in the application launch screen 601 is assumed to be such that two types of creation commercial products are designated, one key design is designated, no designation of contents is inputted, and no designation of design elements is inputted. The commercial product images 711 and 712 displayed on the preview screen 701C are generated by using the design elements extracted from the key design designated in the key design designation region 608, and the commercial product type of the commercial product images 711 and 712 varies from that of the commercial product images 708 and 709. For example, the commercial product images 708 and 709 are postcards, and the commercial product images 711 and 712 are flyers. Two patterns of commercial product images are displayed for each of the varying types on the preview screen 701C as described above. The two commercial product images 708 and 709 are illustrated to vary only in the background color with the key design maintained. Moreover, the two commercial product images 711 and 712 are illustrated to similarly vary only in the background color with the key design maintained. Moreover, the commercial product image 708 of the postcard and the commercial product image 711 of the flyer vary in the type of commercial product and the used image, but have designs with the same key design and the same background color. The commercial product image 709 of the postcard and the commercial product image 712 of the flyer also vary in the type of commercial product and the used image, but have designs with the same key design and the same background color. In other words, on the preview screen 701C, two patterns of designs similar to the key design are generated for each of the varying types of commercial products with the key design maintained. Note that operating the next candidate display button 706 or the previous candidate display button 705 causes other patterns of the commercial product images to be displayed in the screen for each type of commercial product. Selecting multiple types of commercial products on the application launch screen 601 enables generation of multiple design patterns for multiple types of commercial products in one operation. In other words, multiple design patterns can be generated for a combination of multiple commercial products varying in type.

The preview screen 701D illustrated in FIG. 7D illustrates examples of commercial product images generated in the case where a content is designated. The designation information in the application launch screen 601 is different from the designation information in the case of FIG. 7A in that content setting (image setting) is performed. The user can control a content 713 to be included in the generated commercial product by designating a content on the application launch screen 601. A combination of commercial product designs expressing an impression matching the intention of the user can be thereby suitably generated also in the case where a content designated by the user is used. Note that commercial product images 715 and 716 also vary in the size of the background pattern. Variations of the background pattern can be compared with each other by performing a background pattern scaling process to be described later.

### <Commercial Product Impression Quantification>

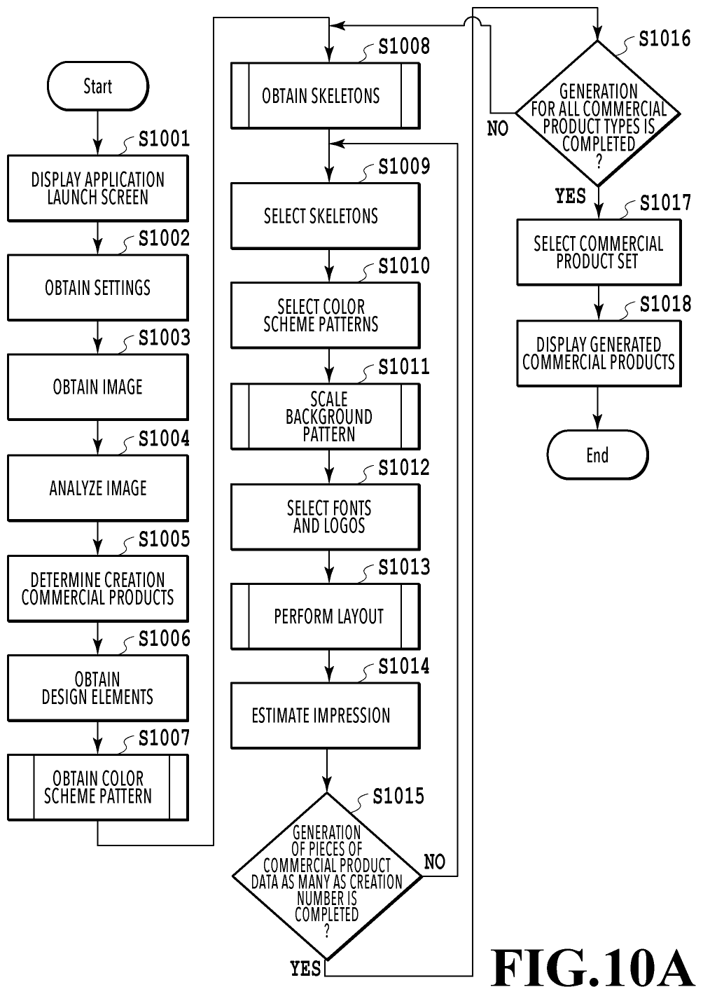

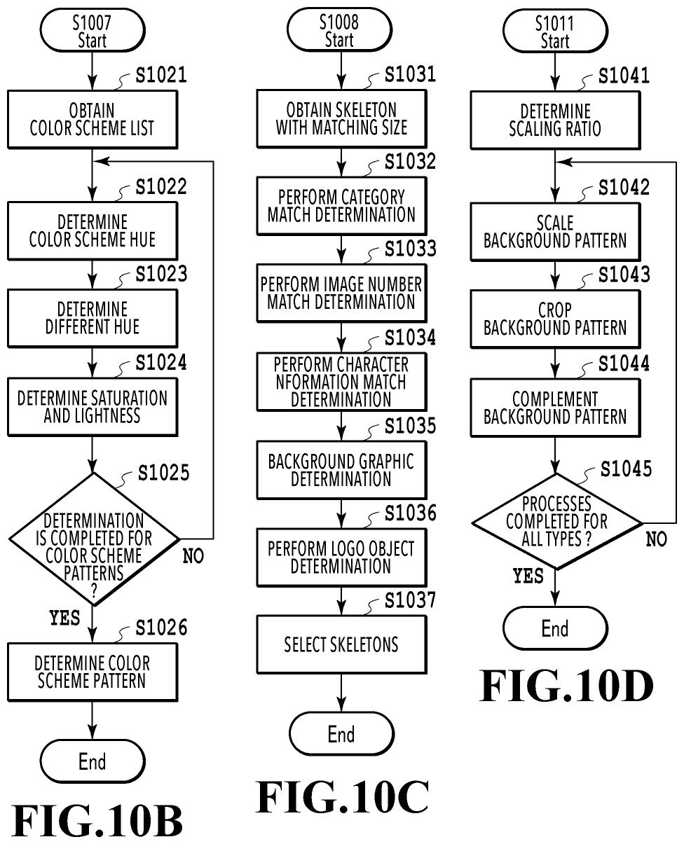

A process (hereinafter, referred to as commercial product impression quantification process) of quantifying the impression of each commercial product is explained. The commercial product impression quantification process is a preliminary process necessary for execution of a commercial product impression estimation process to be described later. The commercial product impression estimation process is executed in a commercial product generation process (S1014 of FIG. 10A) to be described later. In the present embodiment, explanation is given by using a process of quantifying an impression of a poster that is an example of the commercial product. Note that impressions of other commercial products can be also quantified by performing processes similar to the process for the poster. Moreover, for commercial products whose sizes and use applications are close to one another, an impression quantification result of one commercial product can be used as it is for the other commercial product.

A poster impression quantification process is performed in a development stage of the commercial product creation application by a vendor or the like developing the application. Note that the process of quantifying the impression of the poster may be executed in the commercial product generation apparatus 100 or in an information processing apparatus different from the commercial product generation apparatus 100. Note that, in the case where the poster impression quantification process is executed in the information processing apparatus different from the commercial product generation apparatus 100, the poster impression quantification process is executed by a CPU of the information processing apparatus.

In the poster impression quantification process, impressions felt by a person for various posters are quantified. Moreover, correspondence relationships between poster images and the impressions of the posters are derived. This allows an impression of a poster to be estimated from a generated poster image. In the case where the estimation of the impression is possible, it is possible to control the impression of the poster by correcting the poster image or to search for a poster image giving a certain target impression. Note that the poster impression quantification process is executed by, for example, operating an impression learning application for learning the impressions of the poster images in advance in a poster generation apparatus before a poster generation process.

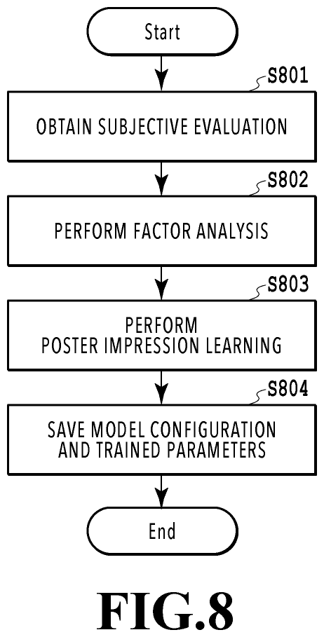

FIG. 8 is a flowchart illustrating the poster impression quantification process. The flowchart illustrated in FIG. 8 is started based on, for example, activation of the impression learning application by a developer, and the CPU 101 implements the flowchart by reading out programs stored in the HDD 104 to the RAM 103 and executing the programs. The poster impression quantification process is explained with reference to FIG. 8. Note that sign “S” in explanation of each process means step in the flowchart. The same applies below in the present specification.

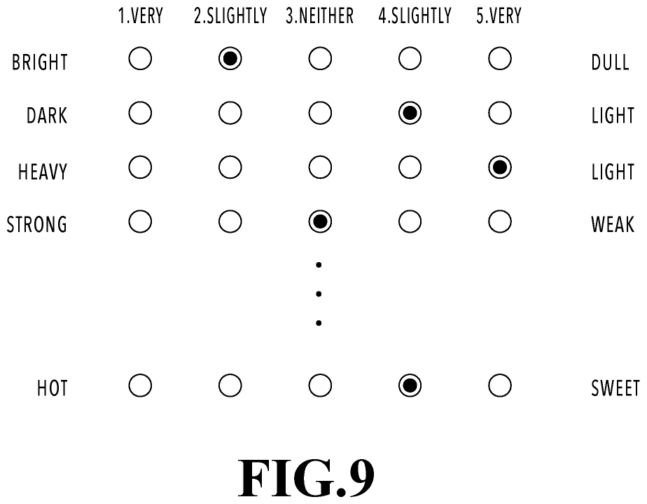

In S801, the CPU 101 obtains a subjective evaluation of the impression of each poster. FIG. 9 is a diagram explaining an example of a subjective evaluation method of the impression of the poster. The CPU 101 presents the poster to a trial subject, and obtains, from the trial subject, the subjective evaluation of the impression received from the poster. In this case, a measurement method such as a semantic differential (SD) method or a Likert scale method can be used. FIG. 9 illustrates an example of a questionnaire that uses the SD method and in which pairs of adjectives representing impressions are presented to multiple evaluators and scoring is performed for the pairs of adjectives evoked by the target poster. The CPU 101 obtains subjective evaluation results of multiple posters from multiple trial subjects, determines an average value of answers for each pair of adjectives, and sets the average value as a representative score of the corresponding pair of adjectives. Note that the subjective evaluation method of the impression may be a method other than the SD method, and it is only necessary that a word expressing the impression and a score corresponding to this word are determined.

In S802, the CPU 101 executes factor analysis of each of the subjective evaluation results obtained in S801. If the subjective evaluation result is used as it is, the number of the pairs of adjectives is equal to the number of dimensions, and the control is complex. Accordingly, it is desirable to reduce the number of dimensions to an efficient number of dimensions by using an analysis method such as principal component analysis or factor analysis. In the present embodiment, explanation is given assuming that the dimensions are reduced to four factors by the factor analysis. As a matter of course, this number may change depending on the selection of the pairs of adjectives in the subjective evaluation and the factor analysis method. Moreover, an output of the factor analysis is assumed to be standardized. Specifically, each factor is scaled such that a mean is 0 and a variance is 1 in the poster used in the analysis. This allows −2, −1, 0, +1, and +2 of the impression designated in the design element designation component 204 to directly correspond to −2σ, −1σ, a mean value, +1σ, and +2σ in each impression, and calculation of the distance between the target impression and the estimated impression to be described later is facilitated. Note that, although the premium feel, affinity, liveliness, and substantial feel illustrated in FIG. 6 are described as the four factors in the present embodiment, these are names given for the sake of convenience to convey the impressions to the user through the user interface, and each factor is formed of multiple pairs of adjectives influencing one another. Moreover, the CPU 101 saves a formula (hereinafter, referred to as “impression conversion formula”) for conversion from the subjective evaluation results of the respective pairs of adjectives obtained by the factor analysis to the values of the respective impressions, in the HDD 104.

In S803, the CPU 101 associates the poster image and the impression with each other. Although the quantification can be performed on the poster subjected to the subjective evaluation in the above-mentioned method, the estimation of the impression needs to be performed also for a poster to be created from here on without the subjective evaluation. The association of the poster image and the impression can be implemented by training a model that estimates the impression from the poster image. For example, a deep learning method using convolution neural network (CNN), a deep learning method using visual transformer (ViT), a machine learning method using a decision tree, or the like may be used for the training. In the present embodiment, the CPU 101 performs supervised deep learning using CNN with the poster image being an input and the four factors being an output. Specifically, the CPU 101 creates a deep learning model trained by using the poster images subjected to the subjective evaluation and the corresponding impressions as correct answers, and inputs an unknown poster image into this learning model to estimate the impression.

In S804, the CPU 101 saves a model configuration and trained parameters of the deep learning model for impression estimation created in S803, in the HDD 104.

The impression estimation component 222 expands the deep learning model saved in the HDD 104 on the RAM 103, and executes the deep learning model. The impression estimation component 222 forms an image of the poster data obtained from the layout component 221, and estimates the impression of the poster by causing the deep learning model expanded on the RAM 103 to operate in the CPU 101 or the GPU 109. Note that, although the deep learning method is used in the present embodiment, the present disclosure is not limited to this. For example, in the case where the machine learning method such as the decision tree is used, there may be created a machine learning model that extracts feature amounts such as a lightness average value, an edge amount, and the like of the poster image by performing image analysis and estimates the impression based on these feature amounts.

### <Commercial Product Generation Process>

FIG. 10A is a flowchart illustrating the commercial product generation process executed by the commercial product generation component 210 of the commercial product creation application. The flowchart illustrated in FIG. 10A is started in the case where the user presses the launch icon of the commercial product creation application as described above. For example, the CPU 101 implements the flowchart illustrated in FIG. 10A by reading out programs stored in the HDD 104 onto the RAM 103 and executing the programs. In the present embodiment, explanation is given assuming that the process is executed by the components that are illustrated in FIG. 2 and that function by execution of the above-mentioned commercial product creation application by the CPU 101. The commercial product generation process is explained with reference to FIG. 10A.

In S1001, the commercial product creation application displays the application launch screen 601 illustrated in FIG. 6, on the display 105. The user inputs various settings through the UI screens of the application launch screen 601 with the keyboard 106 and the pointing device 107.

In S1002, the creation condition designation component 201, the text designation component 202, the image designation component 203, the design element designation component 204, and the key design designation component 205 obtain the settings corresponding to the respective components, from the application launch screen 601.

The creation condition designation component 201 obtains the type and the category of the creation commercial product. The type of the creation commercial product is designated in the creation commercial product designation region 612. The example of FIG. 6 illustrates that two types of commercial products of flyer and postcard are designated as the creation commercial product. The category is designated in the category designation region 611. The example of FIG. 6 illustrates that eating and drinking is obtained as the category.

The text designation component 202 obtains the character information designated in the title box 602, the subtitle box 603, and the main text box 604. The example of FIG. 6 illustrates that character information of “Title 2 Title 2 Title 2” is obtained as the title, and since the subtitle is blank, no character information is obtained for the subtitle. Moreover, the example of FIG. 6 illustrates that character information of four lines of “TextTextText” is obtained as the main text.

The image designation component 203 obtains the image designated in the image designation region 605. The example of FIG. 6 illustrates that the image corresponding to the thumbnail 606 is obtained.

The design element designation component 204 obtains the color scheme, the background pattern, the logo, the font, the target impression, and the reflection degree of these design elements.

The design element designation component 204 obtains the color designated in the color scheme designation box 617, as the color scheme. Moreover, the design element designation component 204 obtains whether the designated color scheme is to be used in the commercial product generation, based on on/off of the corresponding radio button 623. The example of FIG. 6 illustrates that the color expressed in the color 618 is obtained, and is to be used in the commercial product generation. The design element designation component 204 obtains the background pattern designated in the background pattern designation box 620, as the background pattern. Moreover, the design element designation component 204 obtains whether the designated background pattern is to be used in the commercial product generation, based on on/off of the corresponding radio button 623. The example of FIG. 6 illustrates that a check pattern is designated as the background pattern, and is to be used in the commercial product generation.

The design element designation component 204 obtains the logo designated in the logo designation box 621, as the logo. Moreover, the design element designation component 204 obtains whether the designated logo is to be used in the commercial product generation, based on on/off of the corresponding radio button 623. The example of FIG. 6 illustrates that no logo is designated, and no logo is to be used in the commercial product generation. The design element designation component 204 obtains the font designated in the font designation box 622, as the font. Moreover, the design element designation component 204 obtains whether the designated font is to be used in the commercial product generation, based on on/off of the corresponding radio button 623. The example of FIG. 6 illustrates that, although a font of the gothic family is designated, the font is not to be used in the commercial product generation.

The design element designation component 204 obtains the values of the respective impression factors from the impression sliders 624 to 627, as the target impression. Moreover, the design element designation component 204 obtains whether the designated impression factors are to be used in the commercial product generation, based on on/off of the radio buttons 628. The example of FIG. 6 illustrates that −1 is designated for premium feel, +1 is designated for affinity, −0.8 is designated for liveliness, and 0 is designated for substantial feel. Moreover, the example of FIG. 6 illustrates that premium feel and affinity are to be used in the commercial product generation as the target impression, and that liveliness or substantial feel are not to be used in the commercial product generation. The design element designation component 204 obtains the reflection degree designated in the reflection degree slider 629, as the reflection degree. The example of FIG. 6 illustrates that 40% is designated as the reflection degree.

The key design designation component 205 obtains the key design designated in the key design designation region 608. The example of FIG. 6 illustrates that the design data (first creation product data) corresponding to the thumbnail 609 displayed in the key design designation region 608 is obtained as the key design to be the reference of the creation commercial product.

In S1003, the image obtaining component 211 obtains image data. Specifically, the image obtaining component 211 identifies a file of an image corresponding to the thumbnail 606 obtained by the image designation component 203 in S1002, and reads out the identified image file from the HDD 104 to the RAM 103.

In S1004, the image analysis component 212 executes the analysis process on the image data obtained in S1003, and obtains information indicating feature amounts. The information indicating the feature amounts includes, for example, meta information stored in the image and image feature amounts that can be obtained by analyzing the image. These pieces of information are used in the object recognition process and the main color extraction that are the analysis process. Note that, although the object recognition process and the main color extraction are executed as the analysis process in the present embodiment, the present disclosure is not limited to this, and other analysis processes may be executed. Moreover, the process of S1004 may be omitted. Details of the process performed in the image analysis component 212 in S1004 are explained below.

The image analysis component 212 executes the object recognition process on the image obtained in S1003. In this case, a publicly-known method can be used for the object recognition process. In the present embodiment, as the object recognition process, objects are recognized by a discriminator created by deep learning. The discriminator outputs a likelihood of whether a certain pixel forming the image is a pixel forming each object or not in a value of 0 to 1, and recognizes that the object is in the image for the object exceeding a certain threshold. The image analysis component 212 can obtain the types and the positions of objects such as face, flower, food, building, stationary object, landmark, and pets including dog, cat, and the like by recognizing an object image.

Moreover, the image analysis component 212 executes the main color extraction process on the image obtained in S1003, and determines the main color of the image. A publicly-known method can be used for the main color extraction process. In the present embodiment, the number of pixels of each pixel value is counted, and the most-frequently appearing pixel value is determined as the main color. Note that, in the case where the main color is determined based on the pixel value, similar colors such as gradation are processed as different colors, and the determined color is not suitable as the main color in some cases. In this case, as another processing example, the main color may be determined by grouping colors in a range of a predetermined color difference as the same color and counting the number of pixels of each group. The main color additionally including similar colors can be thereby determined, and the main color close to the recognition of a human can be determined. Moreover, a main color degree may be determined based on not only the number of pixels but also the saturation and the lightness of the determined pixel value and a color difference with surrounding pixels. Since colors with high saturation, light colors, and dark colors stand out, these colors are more likely to be recognized as the main color. Moreover, since a color stands out in the case where the color difference with the surrounding pixels is large, the color is more likely to be recognized as the main color. Specifically, the main color degree is determined such that: the higher the saturation is, the higher the main color degree is; the farther the lightness is from a gray color, the higher the main color degree is; and the larger the color difference with the surrounding pixels is, the higher the main color degree is. An example of a determination formula is illustrated in the following formula (5). In formula (5), Mc is the main color degree, Pn is the number of pixels, S is the saturation, L is the lightness, and ΔE is the color difference with the surrounding pixels.

Main color degree Mc=Pn×(S+|50−L|+ΔE) (5)

The image analysis component 212 determines a color with the highest main color degree Mc determined by using the formula (5), as the main color. The main color close to human recognition can be thereby determined. Moreover, the main color extraction process is not limited to the above-mentioned process, and any method may be used. For example, the extraction of the main color may be performed by using a discriminator created by deep learning or by using a clustering method such as K-means. Moreover, there may be multiple main colors instead of one main color.

In S1005, the commercial product generation component 210 determines the commercial products to be created. Specifically, the commercial product generation component 210 determines the commercial product types of the creation commercial products, and the creation number for each commercial product type. The commercial product type is obtained in S1002. In the example of FIG. 6, two commercial product types are designated. Moreover, the commercial product generation component 210 obtains the creation number determined in advance for each commercial product type, and determines a creation number obtained by adding up the creation numbers for all types. In the present embodiment, the creation number determined in advance for each commercial product type is assumed to be five. Specifically, in the example of FIG. 6, ten that is the total of five for postcard and five for the flyer is the creation number. In other words, creation of ten commercial products is determined. In the present embodiment, a commercial product generation result that includes all designated commercial product types and in which one design is selected for each commercial product type is referred to as commercial product set. In the example of FIG. 6, the poster is designated as the key design, and the postcard and the flyer are designated as the creation commercial product. In this case, a combination of the postcard and the flyer that are the creation commercial products is one commercial product set.

Although the creation number is five for each commercial product type in the present embodiment, the creation number is not limited to five, and may be another number. The larger the creation number is, the more likely the commercial product set in which designs of the commercial products are close to the target impression and are similar to each other is generated in many variations. In this case, the designs being similar means that the commercial products include common design elements.

Moreover, processes of S1008 to S1016 to be described later are repeated as many times as the number of types of commercial products to be created, and processes of S1009 to S1015 are repeated as many times as the creation number for each type. Specifically, the processes of S1009 to S1015 are repeated as many times as number of types of commercial products to be created×creation number. In the present embodiment, since the number of types of commercial products to be created is two and the number of commercial products to be created is five, the processes of S1009 to S1015 are repeated ten times.

In S1006, the design element obtaining component 214 obtains the design elements to be used for the creation of the commercial products. Specifically, the design element obtaining component 214 first extracts the design elements from each key design designated in the key design designation component 205.

In the case where the key design is vector data, the design element obtaining component 214 extracts the color scheme, the background pattern, the logo, and the font from tag information. For example, in the case where the key design is stored as SVG data, the design element obtaining component 214 extracts a design element with a large rendering range as the background pattern, and extracts a design element with a small rendering range as the logo. Alternatively, the design element obtaining component 214 may obtain a graphic element in a bottom layer as the background pattern, and extract a graphic element in an upper layer as the logo. In the case where there is a font name in a region of a text tag, the design element obtaining component 214 extracts the font name as the font. The design element obtaining component 214 extracts the color scheme list based on color values included in the tag information. Note that obtaining of the color scheme list is not limited to this method. The design element obtaining component 214 may obtain color scheme information by rasterizing the key design and then performing the main color extraction process described above.

In the case where the key design is raster data, the design element obtaining component 214 performs image region segmentation by using a machine learning model such as deep learning, and obtains the design elements. The design element obtaining component 214 stores the color scheme extracted from the key design as the color scheme list, the background pattern extracted from the key design as the background pattern list, the logo extracted from the key design as the logo list, and the font extracted from the key design as the font list, in the RAM 103.

Next, the design element obtaining component 214 obtains the design elements designated in the design element designation component 204, and stores the obtained color scheme, the background pattern, the logo, and the font in the respective lists. In the case where pieces of actual data of the background pattern, the logo, and the font stored in the lists are saved in the HDD 104 in advance, the design element obtaining component 214 reads these pieces of actual data into the RAM 103 one by one. In the case of the raster data, the design element obtaining component 214 cuts out images based on the result of the image region segmentation, and stores the images one by one in the RAM 103. The color scheme list is held in such a form that the color scheme extracted from the key design and the color scheme designated in the design element designation component 204 are distinguishable.

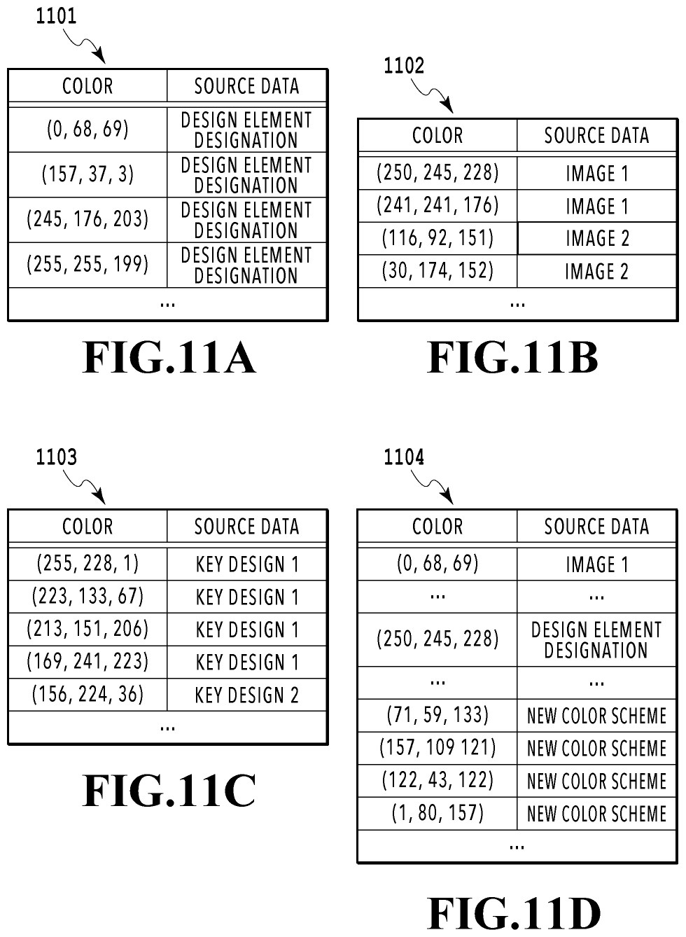

FIGS. 11A to 11D are diagrams illustrating examples of the color scheme lists. FIG. 11A illustrates an example of a color scheme list 1101 of color schemes designated in the design element designation component 204, and FIG. 11B illustrates a color scheme list 1102 obtained from a designated image as a result of analysis by the image analysis component 212. FIG. 11C illustrates an example of a color scheme list 1103 extracted from the key design, and FIG. 11D illustrates an example of a color scheme list 1104 newly generated in a color scheme pattern obtaining process (S1007) to be described later. In each list, information indicating a color and information indicating a type of data being the obtaining source are stored in association with each other. For example, the value of the color is expressed such that a color value of each of R, G, and B is expressed in a value of 0 to 255 in the order of RGB.

In S1007, the color scheme pattern obtaining component 215 obtains the color scheme patterns to be used in the creation of the commercial products. FIG. 10B is a flowchart explaining a color scheme pattern obtaining process executed by the color scheme pattern obtaining component 215 in S1007. Obtaining of the color scheme patterns is explained in detail by using FIG. 10B.

In S1021, the color scheme pattern obtaining component 215 obtains the color scheme list from each of the image analysis component 212 and the design element obtaining component 214. Specifically, the color scheme list 1102 illustrated in FIG. 11B is obtained from the image analysis component 212, and the color scheme list 1101 illustrated in FIG. 11A and the color scheme list 1103 illustrated in FIG. 11C are obtained from the design element obtaining component 214. The color scheme pattern obtaining component 215 registers the color scheme list 1102 obtained from the image analysis component 212 in the new color scheme list 1104, and stores the color scheme list 1104 in the RAM 103. Moreover, the color scheme pattern obtaining component 215 registers the color scheme list 1101 designated by the design element designation component 204 out of the color scheme lists 1101 and 1103 obtained from the design element obtaining component 214, in the above-mentioned new color scheme list 1104. The color scheme pattern obtaining component 215 passes the color scheme list 1103 extracted from the key design out of the color scheme lists obtained in S1006, to S1022.

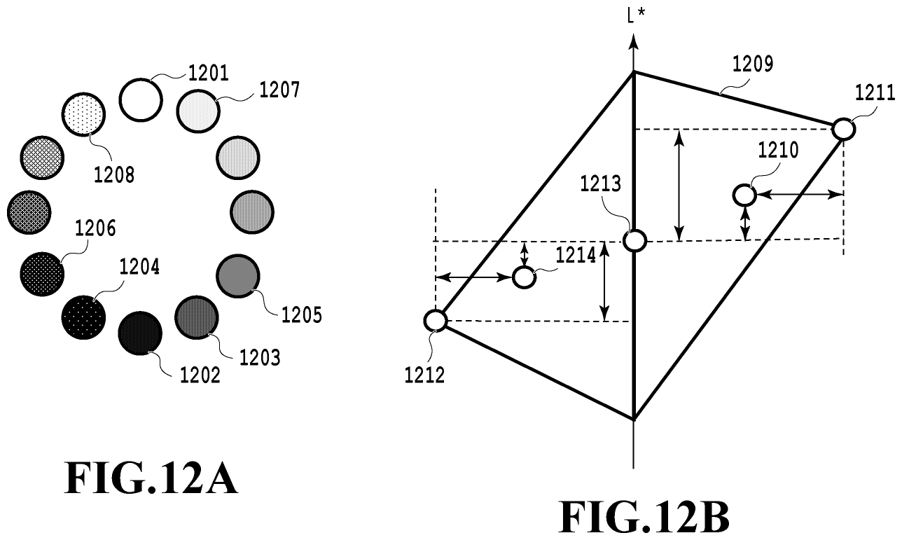

In S1022, the color scheme pattern obtaining component 215 selects one main color in one key design from the color scheme list 1103 received from S1021, and determines the selected color scheme is a color of which hue. In the following explanation, the selected color scheme is referred to as selected color. A specific determination method is explained by using FIG. 12A.

FIG. 12A represents a color circle, and illustrates that hue angles from 0 to 360 degrees are divided into twelve representative colors. For example, yellow, yellow-green, green, blue-green, blue, blue-violet, violet, red-violet, red, red-orange, orange, and yellow-orange are illustrated in this order counterclockwise from a color 1201. The color scheme pattern obtaining component 215 determines which hue does the selected color correspond to. The color scheme pattern obtaining component 215 determines a hue angle between the hues, and determines the representative color closest to the hue angle of the selected color. The hue of the closet representative color is determined as the hue of the selected color.

In S1023, the color scheme pattern obtaining component 215 determines candidates of a hue of a new color scheme, based on the hue of the selected color. The new color scheme is assumed to have a hue different from the hue of the selected color scheme. Specifically, hues in relationships of a complementary color, a contrasting color, and a similar color with respect to the hue of the selected color scheme are determined as the candidates of the hue. In FIG. 12A, assuming the color 1201 is the hue of the selected color, the complementary color is a color 1202, the contrasting color is colors in a range of a color 1205 to a color 1203 and a range of a color 1204 to a color 1206, and the similar color is colors in a range of a color 1207 to a color 1208. The color scheme pattern obtaining component 215 determines one hue of the new color scheme from the colors 1202 to 1208 that are the candidates of the hue. The determination method may be random determination. The hue of the new color scheme may be determined depending on the target impression obtained by the design element obtaining component 214. Specifically, the color scheme pattern obtaining component 215 determines a hue having a value of an impression closest to the target impression among values of impressions associated with the candidates of the hue in advance.

For example, in the case where the numerical value of “liveliness” in the designated target impression is high, red, red-orange, yellow, or yellow-orange with high impression values of “liveliness” is determined as the hue of the new color scheme. Moreover, in the case where the numerical value of “liveliness” in the designated target impression is low, blue-violet, blue, or blue-green with low impression values of “liveliness” is determined as the hue of the new color scheme. Furthermore, for example, in the case where the numerical value of “affinity” in the designated target impression is high, orange, yellow-orange, yellow, yellow-green, or green with high impression values of “affinity” is determined as the hue of the new color scheme. Moreover, in the case where the numerical value of “affinity” in the designated target impression is low, red-violet, violet, blue-violet, or blue with low impression values of “affinity” is determined as the hue of the new color scheme.

Note that the hue of the new color scheme may be determined according to the target impression and a hue relationship. For example, a hue that is in the relationship of the complementary color or the contrasting color with respect to the selected color is determined as the hue of the new color scheme in the case where the numerical value of “liveliness” in the target impression is high, and a hue that is in the relationship of the similar color with respect to the selected color is determined as the hue of the new color scheme in the case where the numerical value of “liveliness” in the target impression is low. The color scheme pattern matching the target impression designated by the user can be thereby determined, and as a result, generation of the commercial products matching the target impression is made possible.

In S1024, the color scheme pattern obtaining component 215 determines the saturation and the lightness of the new color scheme, based on the selected color and the hue of the new color scheme determined in S1023. Specifically, the color scheme pattern obtaining component 215 sets the lightness and the saturation of the new color scheme to the lightness and the saturation of the selected color. Moreover, the color scheme pattern obtaining component 215 sets the hue of the new color scheme to the hue of the color scheme determined in S1023. A color with a hue different from the selected color and with the same lightness and saturation as the selected color can be thereby determined as the new color scheme. The color scheme determined in S1024 is stored in the new color scheme list 1104. In this example, the same color is a color whose lightness difference and saturation difference are equal to or less than a predetermined difference. Equal to or less than the predetermined difference is assumed to be, for example, a case where a spatial distance ΔE in a CIEL*a*b* color space is 6.5 or less. Note that there is a case where a color of the same lightness and the same saturation cannot be expressed in a gamut of sRGB. In this case, the lightness and the saturation of the new color scheme may be determined based on a relationship between the hue of the selected color and the hue of the new color scheme. Specific explanation is given in detail with reference to FIG. 12B.

FIG. 12B illustrates a lightness-saturation plane of a certain hue angle in the CIEL*a*b* color space, and a gamut 1209 represents an sRGB gamut. In the case where the selected color is a position of a color 1210, a maximum-saturation color in the sRGB gamut for the hue of the selected color is a color 1211. Moreover, a maximum-saturation color in the sRGB gamut for the hue of the new color scheme is a color 1212. A color 1213 illustrates an intermediate color (L*=50) on a gray axis (a*=0, b*=0) of the sRGB gamut. A method of determining the new color scheme in this case is explained by using FIG. 12B.

First, a method of determining the lightness is explained. The lightness of a new color scheme 1214 is determined based on a ratio of a lightness difference between the color 1213 and the color 1211 and a lightness difference between the color 1213 and the color 1210. Specifically, the lightness of the new color scheme is determined by the following formula (6), where Ls is the lightness of the color 1210 that is the selected color, Lsh is the lightness of the color 1211 that is the maximum-saturation color for the hue of the selected color, and Lnh is the lightness of the color 1212 that is the maximum-saturation color for the hue of the new color scheme.

$$Lightness of new color scheme = 50 + ( ( Ls - 50 ) \div ( Lsh - 50 ) \times ( Lnh - 50 ) ) \qquad ( 6 )$$

For example, in the case where: the lightness of the color 1211 is 70; the lightness of the color 1210 is 60; and the lightness of the color 1212 is 30, the lightness of the color 1214 is 40.

Next, a method of determining the saturation is explained. The saturation of the new color scheme 1214 is determined from a saturation ratio of the color 1210 and the color 1211 and the saturation of the color 1212. Specifically, the saturation of the new color scheme is determined by the following formula (7), where Hs is the saturation of the selected color 1210, Ssh is the saturation of the color 1211 that is the maximum-saturation color for the hue of the selected color, and Snh is the saturation of the color 1212 that is the maximum-saturation color for the hue of the new color scheme.

$$Saturation of new color scheme = Snh \times ( Hs \div Ssh ) \qquad ( 7 )$$

For example, in the case where: the saturation of the color 1211 is 80; the saturation of the color 1210 is 50; and the saturation of the color 1212 is 60, the saturation of the color 1214 is 37.5.

Performing the calculation as described above allows the lightness and the saturation of the new color scheme to be determined also for the hue in which the same saturation and the same lightness are absent. In the present embodiment, the color only needs to be the same color as the new color scheme determined in the above-mentioned method. The same color is a color whose lightness difference and saturation difference are equal to or smaller than a predetermined difference. Equal to or less than the predetermined difference is, for example, the case where a spatial distance ΔE in the CIEL*a*b* color space is 6.5 or less.

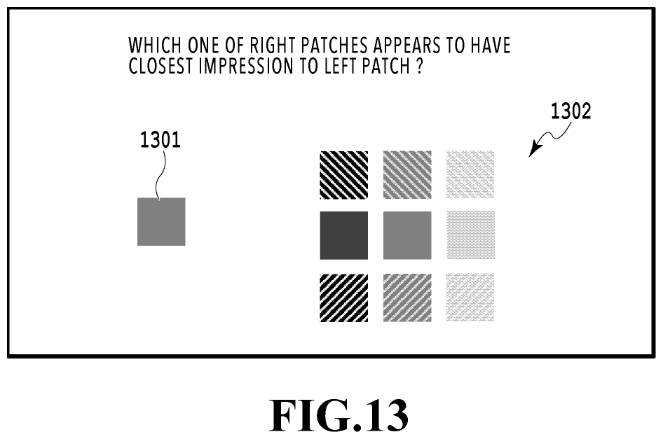

Moreover, the configuration may be such that subjective evaluation by a person is performed in advance for each hue, and saturation and lightness corresponding to each impression are determined. A method of the subjection evaluation is explained with reference to FIG. 13. FIG. 13 illustrates subjection evaluation in which a color that gives the same impression as a color 1301 is selected from among 3×3 patches 1302 on the right side of the color 1301. A center patch of the 3×3 patches 1302 has the lightness and the saturation calculated by using the above-mentioned formulae. Nine patches shifted by +5 and −5 in a lightness direction from the center patch and shifted by +5 and −5 in a saturation direction from the center patch are displayed in the patches 1302. For total of 144 colors that are 12 colors of the colors 1301 varying in hue angle and 12 colors of combinations of the lightness and the saturation, the subjective evaluation is performed for each of 12 color circles. The lightness and the saturation of the new color scheme can be thereby determined to be the lightness and the saturation that appear the same to the human eye, through the subjective evaluation. A color of the new color scheme that gives no feeling of strangeness to the human eye can be thereby determined.

Returning to FIG. 10B, in S1025, the color scheme pattern obtaining component 215 determines whether the new color schemes are determined for all color schemes in the color scheme list obtained in S1021. In the case where the new color schemes are determined for all color schemes, the process transitions to S1026. If not, the process transitions to S1022.

In S1026, the color scheme pattern obtaining component 215 obtains color scheme patterns from the colors in the determined new color scheme list 1104. In the case where there are identical colors in the new color scheme list 1104, the colors are merged to form a unique color. The basic color scheme pattern is the color scheme pattern extracted from the key design. The colors stored in the new color scheme list 1104 are replaced as the main color of the color scheme pattern, and thus-created color scheme patterns are stored in the color scheme pattern list as new color scheme patterns. Color scheme patterns with hues different from the key design can be thereby obtained. Moreover, instead of replacing the main color, colors other than the main color that are included in the color scheme pattern may be changed depending on the new color schemes. For example, hue angles of the colors other than the main color may be changed depending on a hue angle difference between each new color scheme and the main color before the replacement. The color scheme pattern obtaining component 215 stores the changed color scheme patterns in the color scheme pattern list. Note that both of the method of replacing the main color and the method of changing the colors other than the main color may be performed. This can increase the number of types of new color scheme patterns. Moreover, the color scheme pattern obtaining component 215 may add new color scheme patterns from a preferable color scheme pattern group stored in advance, depending on the new color schemes. In the case where colors included in the color scheme pattern group stored in advance include the new color schemes, color scheme patterns corresponding to the new color schemes are stored in the color scheme pattern list as the new color scheme patterns. This enables generation of wider variations of commercial products. That is the explanation of the color scheme pattern obtaining process in S1007. Description returns to the explanation of FIG. 10A.

In S1008, the skeleton obtaining component 213 obtains skeletons matching various setting conditions, for the commercial product types being the processing targets. In the present embodiment, the skeletons are assumed to be such that one skeleton is described in one file and saved in the HDD 104. The skeleton obtaining component 213 sequentially reads out the skeleton files from the HDD 104 to the RAM 103, and keeps the skeletons matching the setting conditions on the RAM 103 while deleting the skeletons not matching the conditions from the RAM 103.

FIG. 10C is a flowchart explaining a condition determination process executed by the skeleton obtaining component 213 in S1008. The condition determination process is explained in detail with reference to FIG. 10C.

In S1031, for each of the skeletons read into the RAM 103, the skeleton obtaining component 213 determines whether the size set in advance for each type of commercial product being the processing target matches the size of the skeleton. For example, assume that the sizes of the flyer and the postcard designated as the creation commercial products in the application launch screen 601 are A4 and 100 mm×148 mm, respectively. Note that, although the size match is checked in this example, matching of the aspect ratio alone is sufficient. In this case, the skeleton obtaining component 213 enlarges or reduces the coordinate system of the read skeleton to obtain a skeleton matching the size of the commercial product being the processing target.

In S1032, the skeleton obtaining component 213 determines whether the use application category designated in the creation condition designation component 201 matches the category of the skeleton. In a skeleton to be used only for a specific use application, the use application category of this skeleton is described in the skeleton file, and this skeleton is prevented from being obtained except for the case where this use application category selected. This can prevent the skeleton from being used in other use application categories in the case where the skeleton is designed specifically for a certain use application such as, for example, the case where a pattern evoking school is graphically drawn or the case where a pattern of sport goods is graphically drawn. Note that, in the case where no use application category is set in the application launch screen 601, S1032 is skipped.

In S1033, the skeleton obtaining component 213 determines whether the number of image objects arranged in the read skeleton matches the number of images obtained by the image obtaining component 211. In S1034, the skeleton obtaining component 213 determines whether the text objects arranged in the read skeleton match the character information designated in the text designation component 202. More specifically, the skeleton obtaining component 213 determines whether each type of character information designated in the text designation component 202 is present in the skeleton. For example, assume that character strings are designated in the title box 602 and the main text box 604 on the application launch screen 601, and blank is designated in the subtitle box 603. In this case, the skeleton obtaining component 213 searches all text objects arranged in the skeleton, and determines that the skeleton is suitable in the case where the text object for which “title” is set as the type of character information in the metadata and the text object for which “main text” is set as the type are both found, and determines that the skeleton is unsuitable in other cases.

In S1035, the skeleton obtaining component 213 determines whether a background graphical object is present in the read skeleton. The background graphical object needs to present in the skeleton to render the background pattern obtained from the key design. The determination of whether the background graphical object is present or not is assumed to be performed such that whether each graphical object is a background or not is set in advance as metadata of the graphical object, and the determination is performed based on information of the metadata. Alternatively, a graphical object with the largest area among graphical objects used as backgrounds of other design elements may be determined as the background object.

In S1036, the skeleton obtaining component 213 determines whether a logo object is present in the read skeleton. In the case where a logo is designated in the creation condition designation component 201, an object for rendering a logo needs to be present in the skeleton. In the case where no logo is designated in the creation condition designation component 201, S1036 is skipped.

As a result of the above-mentioned process, skeletons whose size, use application category, number of image objects, types of text objects, presence or absence of the background graphical object, and presence or absence of the logo object all match the setting conditions are held in the RAM 103.

In S1037, the skeleton obtaining component 213 selects the skeletons remaining in the RAM 103 as the skeletons to be used for the commercial product generation.

Note that, although the skeleton obtaining component 213 performs the determination for all skeleton files stored in the HDD 104 in the present embodiment, the present disclosure is not limited to this. For example, the commercial product creation application may hold a database in which file paths of the skeleton files are associated with the search conditions in advance, in the HDD 104. In this case, the skeleton obtaining component 213 can obtain the skeleton files at high speed by reading only the skeleton files determined to match the conditions as a result of searching on the database, from the HDD 104 to the RAM 103. Note that the searching conditions are, for example, the skeleton size, the number of image objects, the types of text objects, presence or absence of the background graphical object, and presence or absence of the logo object. That is the explanation of S1008. Description returns to the explanation of FIG. 10A.

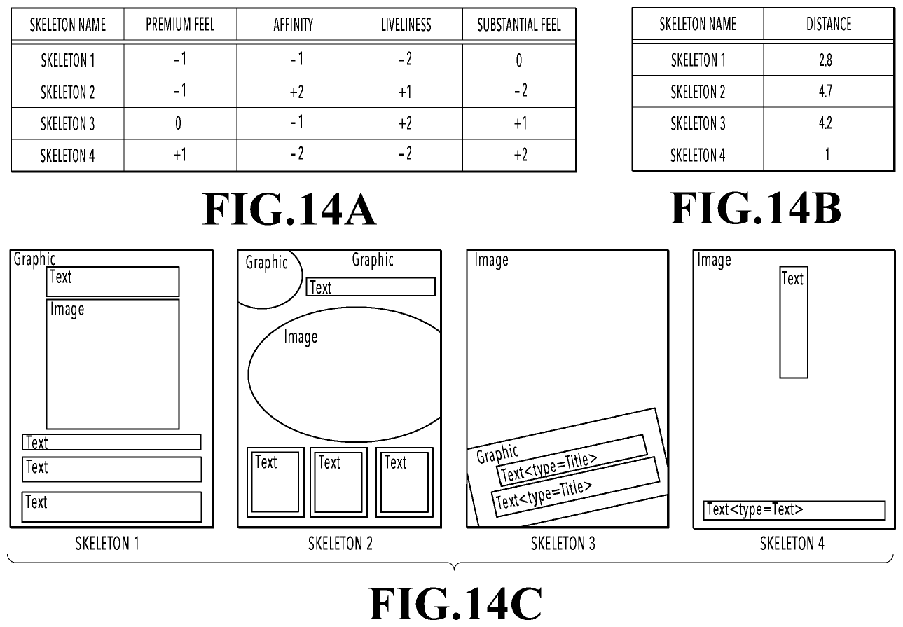

In S1009, the skeleton selection component 216 selects the skeletons matching the target impression obtained by design element obtaining component 214 among the skeletons obtained in S1008. FIGS. 14A to 14C are diagrams explaining selection of the skeletons for the poster that is an example of the commercial product. Note that the same applies to commercial product types other than the poster.

FIG. 14A is a diagram illustrating an example of a skeleton impression table in which the skeletons are associated with the impressions of the skeletons. In the column of skeleton name in the table illustrated in FIG. 14A, a file name of each skeleton is described, and the columns of premium feel, affinity, liveliness, and substantial feel each illustrate a number (numerical value) indicating a level of an influence of each skeleton on a corresponding one of the impression factors. This numerical value is a value indicating that −2 is low, −1 is slightly low, 0 is neither high nor low, +1 is slightly high, and +2 is high for the corresponding impression factor. First, the skeleton selection component 216 determines a distance between the target impression obtained from the design element obtaining component 214 and the impression of each of the skeletons illustrated in the skeleton impression table of FIG. 14A. Hereinafter, a distance between two impression values is referred as impression distance. For example, in the case where the target impression is “premium feel+1, affinity −1, liveliness −2, and substantial feel +2”, the impression distance determined by the skeleton selection component 216 is as illustrated in FIG. 10B. Note that, in the present embodiment, a Euclidean distance is used as the distance. Hereinafter, impression distance means Euclidean distance unless otherwise noted. The smaller the value indicated by the Euclidean distance is, the closer the impression of the skeleton is to the target impression. Next, the skeleton selection component 216 selects top N skeletons in ascending order of the value indicated by the impression distance in FIG. 14B. In the present embodiment, the skeleton selection component 216 selects top two skeletons in ascending order of the value of the impression distance. In the example of FIG. 14B, Skeleton 1 and Skeleton 4 are selected. The value of N may be any value that is an integer of one or more.

Note that the range of the impression in the skeleton impression table in FIG. 14A does not have to be the same as the range of the impression designated in the design element designation component 204. Although the range of the impression designated in the design element designation component 204 is −2 to +2 in the present embodiment, the range of the impression in the skeleton impression table may be different from this range. In the case where the ranges are different, the range in the skeleton impression table is scaled to match the range of the target impression, and then the above-mentioned impression distance is determined. Furthermore, the distance determined by the skeleton selection component 216 is not limited to the Euclidean distance, and may be a Manhattan distance, a Cosine similarity, or the like as long as a distance between vectors can be determined. Moreover, the impression factors for which the radio buttons 628 on the application launch screen 601 are set to off are excluded from the distance determination targets.

The skeleton impression table of FIG. 14A is created in advance, and saved in the HDD 104. For example, the impression of each skeleton is estimated based on poster images generated with the color scheme pattern, the font, and the image and character data arranged on the skeleton fixed. Specifically, the impression of each of the poster images that are the same in the used images, the colors of used characters, and the like but vary in the arrangement of the characters, images, and the like is estimated. Characteristics relative to other skeletons are thereby formed into a table. In this case, it is desirable to perform a process of cancelling impressions given by the used color scheme pattern, image, and the like such as performing standardization across all estimated impressions, averaging impressions of multiple poster images generated from one skeleton by using multiple color scheme patterns and multiple images, or the like. Influences of the arrangement on the impression can be thereby formed into a table, the influences being, for example, such an influence that an impression of a skeleton with a small image is determined based on design elements such as graphics and characters irrespective of the image and such an influence that an impression of liveliness is high in the case where images and characters are arranged in a tilted manner.

FIG. 14C is examples of skeletons corresponding to Skeleton 1 to Skeleton 4 in FIG. 14A. For example, in Skeleton 1, an image object and text objects are regularly arranged, and the area of the image is small. Accordingly, liveliness is low. In Skeleton 2, a graphical object and an image object are circular. Accordingly, affinity is high, and substantial feel is low. In Skeleton 3, an image object is arranged in a large area, and a tilted graphical object is arranged to be laid over the image object. Accordingly, liveliness is high. In Skeleton 4, an image is arranged over the entire skeleton, and a text object is minimized. Accordingly, substantial feel is high, and liveliness is low. As described above, in the case where the poster image includes characters or an image, poster images varying in the target impression are generated by the arrangement method of the characters or the image. Note that the method of creating the skeleton impression table is not limited to this, and the skeleton impression table may be estimated from features of arrangement information itself such as areas and coordinates of images and title character strings, or may be manually adjusted. The skeleton impression table is saved in the HDD 104, and the skeleton selection component 216 reads out the skeleton impression table from the HDD 104 to the RAM 103, and refers to the skeleton impression table.

In S1010, the color scheme pattern selection component 217 selects the color scheme patterns matching the target impression obtained by the design element obtaining component 214, from the color scheme patterns obtained in S1007. A method of selecting the color scheme patterns matching the target impression is similar to the skeleton selection of S1009. Specifically, the color scheme pattern selection component 217 refers to an impression table corresponding to the color scheme pattern, and selects the color scheme patterns giving an impression close to the target impression.

FIG. 15 illustrates an example of a color scheme pattern impression table in which the color scheme patterns and the impressions are associated with one another. The color scheme pattern selection component 217 determines an impression distance between a value of each of the impression factors indicated by the columns of premium feel to substantial feel in FIG. 15 and a value of each of the impression factors of the target impression obtained by the design element obtaining component 214. Then, the color scheme pattern selection component 217 selects top N color scheme patterns in ascending order of the value of the impression distance. In the present embodiment, top two color scheme patterns are selected. Note that the color scheme pattern impression table of FIG. 15 is created in advance in a method similar to the skeleton impression table, and saved in the HDD 104. Specifically, the impression of each color scheme pattern is estimated based on poster images generated with the skeleton, the font, and the image that are the design elements other than the color scheme pattern fixed. Tendencies of the impressions of the color scheme patterns can be thereby formed into a table. In a method of selecting the color scheme pattern matching the designated color, a color close to the color included in the color scheme pattern is selected. For example, in the case where a color scheme pattern includes a color whose ΔE being the distance in the CIE L*a*b* color space is 2.0 or less, this color is selected. Alternatively, a distance ΔRGB in a RGB color space being 1.0 or less may be used as a criterion. Specifically, in the case where the designated color is (R, G, B)=(0, 67, 69), the distance ΔRGB between the designated color and Color 1 in the color scheme ID of “1” in the color scheme pattern impression table of FIG. 15 is 1.0 or less, and the color scheme pattern with the color scheme ID of “1” is thus selected.

In S1011, the background pattern scaling component 218 enlarges or reduces the background pattern obtained by the design element obtaining component 214 for each commercial product, and changes the size. The background pattern scaling component 218 outputs the scaled background pattern to the layout component 221 in association with the commercial product.

FIG. 10D is a flowchart explaining a scaling process executed by the background pattern scaling component 218 in S1011. The scaling process of the background pattern is explained in detail with reference to FIG. 10D.

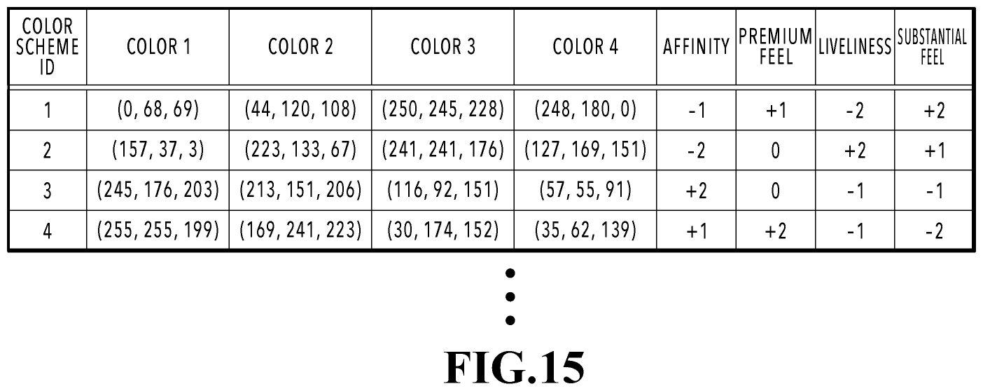

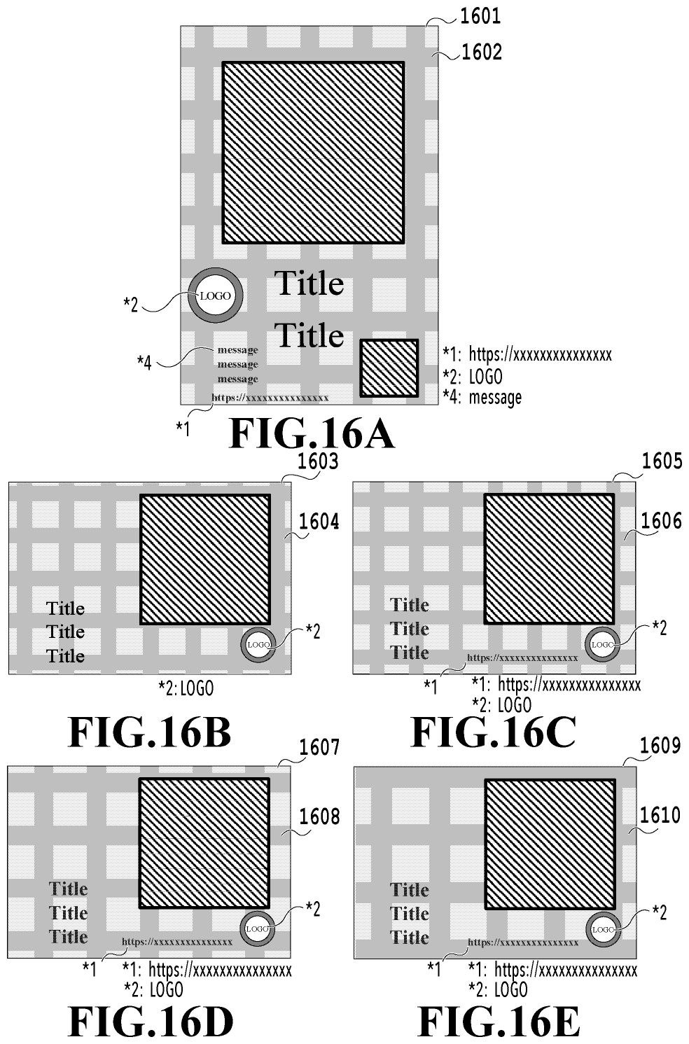

In S1041, the background pattern scaling component 218 determines a scaling ratio for scaling the background pattern. FIGS. 16A to 16E are diagrams explaining examples of scaling of the background pattern. In FIGS. 16A to 16E, explanation is given of examples in which a flyer is designated as the key design and a postcard is designated as the creation commercial product. FIG. 16A illustrates the flyer designated as the key design. A check pattern is used as a background pattern 1602 in the flyer 1601. FIG. 16B is an example of the postcard generated by the commercial product generation component 210. A background pattern 1604 reduced by the background pattern scaling component 218 is arranged in the postcard 1603. Note that “reduced” is reduction with respect to the background pattern 1602 of the key design. FIGS. 16C, 16D, and 16E are diagrams explaining differences in the scaling ratio of the background pattern, and illustrate postcards varying in the scaling ratio of the background pattern, respectively. The scaling ratio is a scaling ratio of each of background patterns 1606, 1608, and 1610 in the postcards 1605, 1607, and 1609 to the background pattern 1602 in the flyer 1601 that is the key design.

The scaling ratio of the background pattern 1606 in the postcard 1605 illustrated in FIG. 15C corresponds to a size ratio (in this case, an area ratio) of the postcard 1605 to the flyer 1601.

Moreover, the scaling ratio of the background pattern 1608 in the postcard 1607 illustrated in FIG. 16D is 1, and the background pattern 1608 is the same size as the background pattern 1602 in the flyer 1601. Specifically, the background pattern 1608 that is not scaled is arranged in the postcard 1607.

The scaling ratio of the background pattern 1604 reduced by the background pattern scaling component 218 and illustrated in FIG. 16B described above is set to a value between the scaling ratio of the background pattern 1606 in FIG. 16C and the scaling ratio (=1) of the background pattern 1608 in FIG. 16D. For example, the background pattern scaling component 218 determines the scaling ratio R according to the following formula (8).

$$R = D 1 \div D 2 \times C 2 \div C 1 \qquad ( 8 )$$

In this formula, C1 is the length of the diagonal line of the key design, and C2 is the length of the diagonal line of the commercial product to be created. Moreover, D1 is the expected viewing distance of the key design, and D2 is the expected viewing distance of the commercial product to be created. Note that the formula (8) corresponds to the formulae (2) and (3) described above.

In the formula (8), the background pattern scaling component 218 determines a scaling ratio R corresponding to the expected viewing distances of two commercial products varying in size and the sizes of the respective commercial products themselves. Accordingly, similarity in appearance between the two commercial products is increased, and the two commercial products are more likely to express a common brand than in the cases of FIGS. 16C and 16D. For example, assume that, in the creation condition designation component 201, the expected viewing distance of an A4-size flyer (297 mm×210 mm) is designated to be 40 cm, and the expected viewing distance of an official-postcard-size postcard (148 mm×100 mm) is designated to be 30 cm. In this case, the scaling ratio R calculated by using the formula (8) is 0.65. Note that the scaling ratio Re of the background pattern 1608 in FIG. 16D is the same size (=1), and the scaling ratio Rs of the background pattern 1606 in FIG. 16C is a commercial product size ratio (ratio between the lengths of the diagonal lines of the respective commercial products) Rs. These ratios are expressed by the following formulae (9) and (10).

$$Re = 1 \qquad ( 9 )$$

$$Rs = ( ( 148 \times 100 ) \div ( 297 \times 210 ) ) \hat{} 0.5 = 0.49 \qquad ( 10 )$$

The scaling ratio R in FIG. 16B is larger than the commercial product size ratio Rs (ratio between the lengths of the diagonal lines of the respective commercial products), and is smaller than the ratio Re (=1) at which the size of the background pattern is the same as the size of the background pattern in the key design. In other words, a relationship of Rs<R<Re is established.

As described above, in the case where the size of the creation commercial product is smaller than the size of the commercial product to be the reference (key design), the scaling ratio R is larger than the commercial product size ratio Rs (ratio between the lengths of the diagonal lines of the respective commercial products), and is smaller than the ratio Re (=1) at which the size of the background pattern is the same as the size of the background pattern in the key design. In other words, the relationship of Rs<R<Re is established. The size of the background pattern in the creation commercial product (second creation product data) is thereby smaller than the size of the background pattern in the key design (first creation product data), and is larger than the size of the background pattern obtained by reducing the background pattern in the key design by the size ratio C₁₂ of the creation commercial product to the key design.

Note that it is generally assumed that the smaller the commercial product size is, the smaller the viewing distance is, and the larger the commercial product size is, the larger the viewing distance is. For example, the viewing distance of the business card is smaller than the viewing distance of the poster with a larger size. However, there are many cases where the ratio of the viewing distances does not match the ratio of the commercial product sizes. In the case where the background pattern 1606 (FIG. 16C) corresponding to the commercial product size ratio is arranged in the commercial product in such a case, the user visually recognizing this commercial product recognizes that the pattern is finer than that in the key design. Meanwhile, in the case where the background pattern 1608 (FIG. 16D) corresponding to the same size is arranged in the commercial product, the user visually recognizing this commercial product recognizes that the pattern is coarser than that in the key design. Performing the scaling of the background pattern scaling component 218 in the present embodiment for such strange feeling in appearance enables setting of a scaling ratio taking both of the viewing distance and the commercial product size into consideration, and appearance of the background pattern of the commercial product can be brought closer to appearance of the key design.

Although the scaling method of the background in the case where the commercial product to be created is smaller than the commercial product of the key design is explained in the examples of FIGS. 16A to 16E, a similar method can be applied also to the case where the creation commercial product is larger than the commercial product of the key design. For example, assume that the key design is an A4-size flyer and the viewing distance thereof is 40 cm and that the creation commercial product is an A1-size (594 mm×841 mm) commercial product and the viewing distance thereof is 100 cm. In this case, the scaling ratio R calculated by using the formula (8) is 2.5. This scaling ratio R has a relationship of Re<R<Rs with respect to the commercial product size ratio Rs=2.83 between A4 and A1.

As described above, in the case where the size of the creation commercial product is larger than the size of the commercial product to be the reference (key design), the scaling ratio R is smaller than the commercial product size ratio Rs (ratio between the lengths of the diagonal lines of the respective commercial products), and is larger than the ratio Re (=1) at which the size of the background pattern is the same as the size of the background pattern in the key design. In other words, the relationship of Re<R<Rs is established. The size of the background pattern in the creation commercial product (second creation product data) is thereby larger than the size of the background pattern in the key design (first creation product data), and is smaller than the size of the background pattern obtained by enlarging the background pattern in the key design by the size ratio C₁₂ of the creation commercial product to the key design.

Note that, although C1 and C2 are the lengths of the diagonal lines in the formula (8), C1 and C2 do not have to be the lengths of the diagonal lines as long as they are values representing the commercial product sizes. For example, C1 and C2 may be the lengths of corresponding sides of the commercial products, square roots of the areas, or the areas. The same applies to the following formulae.

Moreover, the determination method of the scaling ratio of the background pattern is not limited to the above method. For example, the scaling ratio R of the background pattern may be determined according to the following formula (11).

$$R = D 1 \div D 2 \times F 2 \div F 1 \qquad ( 11 )$$

In this formula, D1 is the expected viewing distance of the key design, and D2 is the expected viewing distance of the commercial product to be created. F1 is the maximum font size used in the key design, and F2 is the maximum font size in the commercial product to be created. Using a font size independent of the commercial product size allows a relative size ratio between the background pattern and the characters to be taken into consideration. Accordingly, it is possible to improve uniform feel for the sizes of the characters and the background pattern in commercial products that attract attentions with characters such as a shop name and a discount percentage. Note that, although F1 and F2 are the maximum font sizes, F1 and F2 are not limited to this, and may be sizes of representative fonts such as title fonts.

Moreover, as another example, the background pattern scaling component 218 may determine the scaling ratio R of the background pattern according to the following formula (12).

$$R = D 1 \div D 2 \qquad ( 12 )$$

In this formula, D1 is the expected viewing distance of the key design, and D2 is the expected viewing distance of the commercial product to be created. Since the scaling ratio is determined based on only the expected viewing distances in this case, the size of the background pattern appears to be the same size as the key design in the case where the commercial product is viewed at the viewing distance expected by the user.

Note that, in the case where the value of R determined by using the formula (11) or (12) described above is not between the commercial product size ratio and 1, the value is excluded from candidates of the scaling ratio R. The background pattern scaling component 218 determines the scaling ratio in another method.

As another example, the background pattern scaling component 218 may determine the scaling ratio R of the background pattern according to the following formula (13).

$$R = ( 1 + C 2 \div C 1 ) \div 2 \qquad ( 13 )$$

In this formula, C1 is, for example, the length of the diagonal line of the key design, and C2 is, for example, the length of the diagonal line of the commercial product to be created. In this case, the scaling ratio R is determined to be a value in the middle of the commercial product size ratio and 1, irrespective of the viewing distances. For example, a relatively-stable design can be generated also in the case where the expected viewing distances cannot be determined to be specific values.

Moreover, the background pattern scaling component 218 may dynamically adjust the scaling ratio depending on the arrangement of the background pattern. In FIG. 16E, horizontal lines of the check pattern in the background pattern 1610 are in contact with an upper end and lower end of the commercial product, and the background pattern 1610 has an appearance different from the design of the flyer 1601 that is the key design. In the case where the background pattern scaling component 218 detects mismatch of the design as described above, the background pattern scaling component 218 may change the scaling ratio in increments of a fine amount ΔR and search for the scaling ratio at which no mismatch of design is detected.

Moreover, the background pattern scaling component 218 may output background patterns scaled by multiple scaling ratios R, to the layout component 221. For example, the background pattern scaling component 218 outputs all background patterns scaled by scaling ratios R satisfying the relationship of Re<R<Rs in the case of enlargement or satisfying the relationship of Rs<R<Re in the case of reduction, among the scaling ratios R calculated by using the formulae (8) to (12), to the layout component 221. Then, the impression distance between the target impression and the impression after layout is evaluated in the commercial product selection component 223. Accordingly, it is possible to select a background pattern even closer to the target impression while maintaining a balance between the commercial product size and the background pattern size. That is the explanation of the scaling ratio determination process of the background pattern performed in S1041. Description returns to the explanation of FIG. 10D.

In S1042, the background pattern scaling component 218 scales the background pattern obtained from the design element obtaining component 214 by the scaling ratio determined in S1041. In S1043, the background pattern scaling component 218 crops the background pattern scaled in S1042, according to the commercial product size. In S1044, the background pattern scaling component 218 complements a portion of the background pattern cropped in S1043 where the background pattern is not enough for the background region of the commercial product.

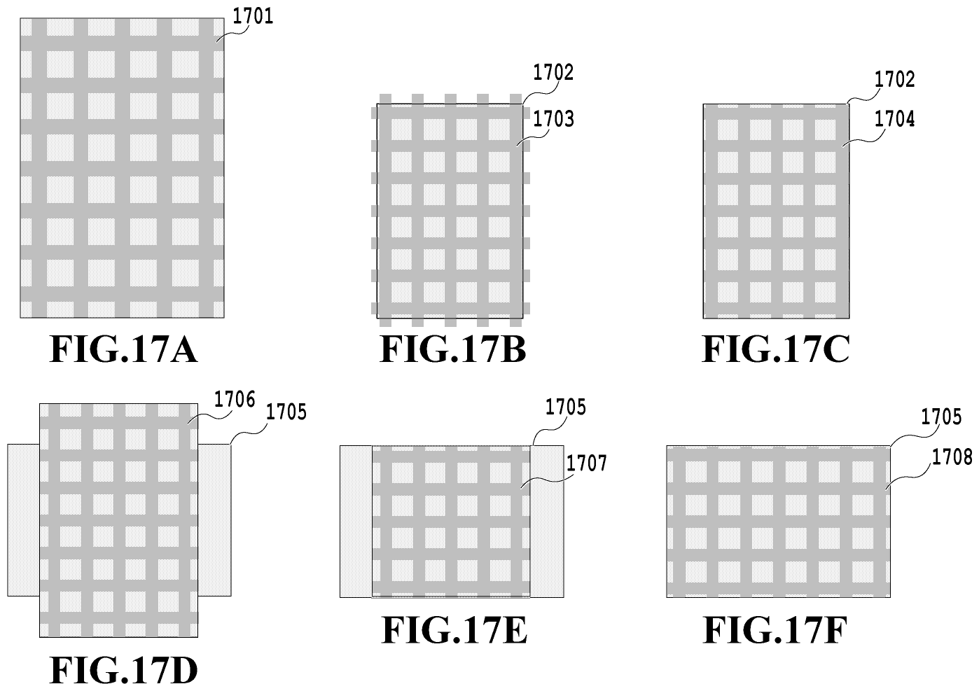

FIGS. 17A to 17F are diagrams explaining the processes of S1042 to S1044. FIG. 17A illustrates a background pattern 1701 obtained from the design element obtaining component 214. FIG. 17B is an example of the background pattern scaled in S1042, and the size of a background pattern 1703 is larger than the size of a commercial product 1702. FIG. 17C illustrates a background pattern 1704 created by cropping the background pattern 1703 in S1043, and the size of the cropped background pattern 1704 is the same as the size of the commercial product 1702. Since there is no portion where the background pattern is not enough for the background region of the commercial product in FIG. 17C, no process is performed in S1044.

FIG. 17D is an example of a background pattern scaled for a commercial product 1705 different from the commercial product in FIG. 17B in S1041. The size of the background pattern 1706 is larger than the size of the commercial product 1705 in the vertical direction, but is smaller than the size of the commercial product 1705 in the horizontal direction. FIG. 17E illustrates a background pattern 1707 created by cropping the background pattern 1706 in S1042. FIG. 17F illustrates a background pattern 1708 created by complementing the background pattern 1707 in S1044. Note that the background pattern 1708 can be created by repeatedly arranging the background pattern 1707 in the horizontal direction. Alternatively, the background pattern 1708 can be created by generating portions outside the background pattern 1707 with an out-painting function of a generative AI. In this case, left and right end portions of the commercial product image 1705 illustrated in FIG. 17E where no background pattern 1707 is assigned are masked and subjected to out-painting, and the complemented image can be thereby obtained.

In S1045, the background pattern scaling component 218 determines whether the scaling process of S1041 to S1044 is completed for all commercial products being the creation targets. In the case where the process is not completed for all commercial products, the process returns to S1041. In the case where the process is completed for all commercial products, the present flowchart is terminated, and the process transitions to S1012 of FIG. 10A. That is the explanation of the background pattern scaling process in S1011. Description returns to the explanation of FIG. 10A.

In S1012, the logo selection component 219 selects a combination of logos matching the target impression from a logo list obtained in the design element obtaining component 214. A selection method of the combination of logos matching the target impression may be a method similar to S1009. Specifically, the logo selection component 219 refers to a logo impression table illustrating impression values corresponding to the respective logos, and selects logos depending on the target impression.

Moreover, in S1012, the font selection component 220 selects a combination of fonts matching the target impression obtained in the design element obtaining component 214. A selection method of the combination of fonts matching the target impression is such that the font selection component 220 refers to an impression table corresponding to fonts, and selects fonts depending on the target impression in a method similar to S1009.

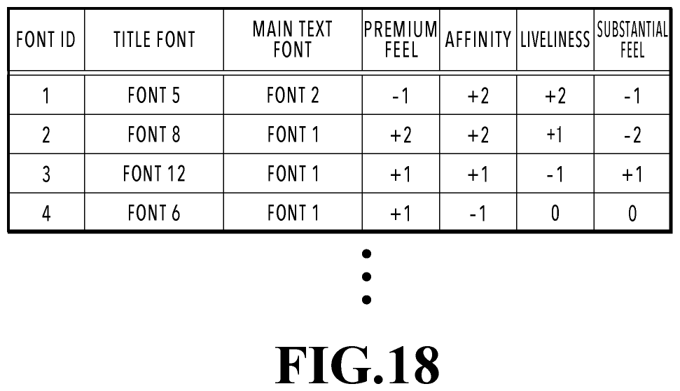

FIG. 18 illustrates an example of the font impression table in which fonts are associated with impressions. The font selection component 220 determines impression distances based on values of the respective impression factors illustrated by the columns of premium feel to substantial feel in FIG. 18 and values of the respective impression factors of the target impression. Then, the font selection component 220 selects top N fonts in ascending order of the value of the impression distance. Note that the font impression table of FIG. 18 is created in advance in a method similar to the method for the skeleton impression table, and is saved in the HDD 104. Specifically, the impression of each font is estimated based on poster images generated with the font changed and with the skeleton, the color scheme pattern, and the image that are the design elements other than the font fixed. Tendencies of the impressions of the fonts can be thereby formed into a table. In the method of selecting the combination of fonts matching the designated font, a combination of fonts including the designated font is selected. In addition, a combination of fonts having impression values close to impression values of the fonts in the combination of fonts including the designated font may be further selected. Fonts that give impressions close to the impression of the designated fonts can be thereby also selected.

In S1013, the layout component 221 sets the character information, the image, the color scheme, the fonts, the background pattern, and the logo in each skeleton selected by the skeleton selection component 216, and generates a design of the commercial product.

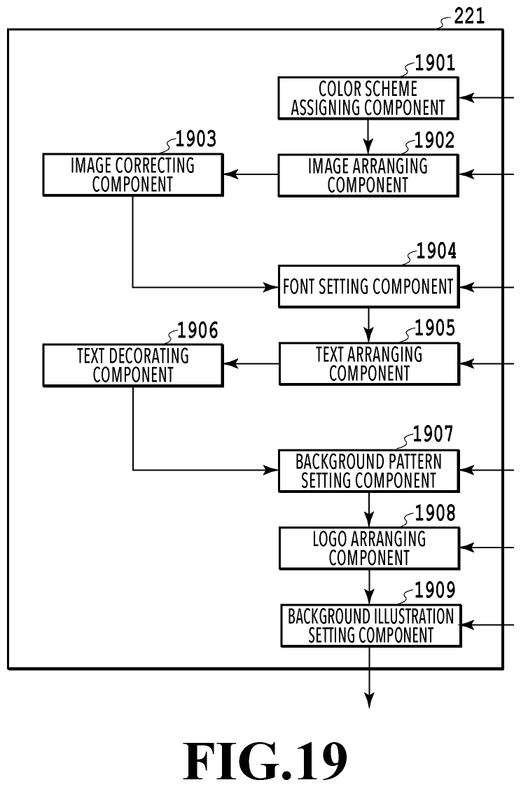

The process of S1013 and a software configuration of the layout component 221 are explained in detail by using FIGS. 19, 20, 21A to 21C, and 22A to 22D.

FIG. 19 is an example of a software block diagram explaining the layout component 221 in detail. The layout component 221 includes a color scheme assigning component 1901, an image arranging component 1902, an image correcting component 1903, a font setting component 1904, a text arranging component 1905, a text decorating component 1906, a background pattern setting component 1907, a logo arranging component 1908, and a background illustration setting component 1909.

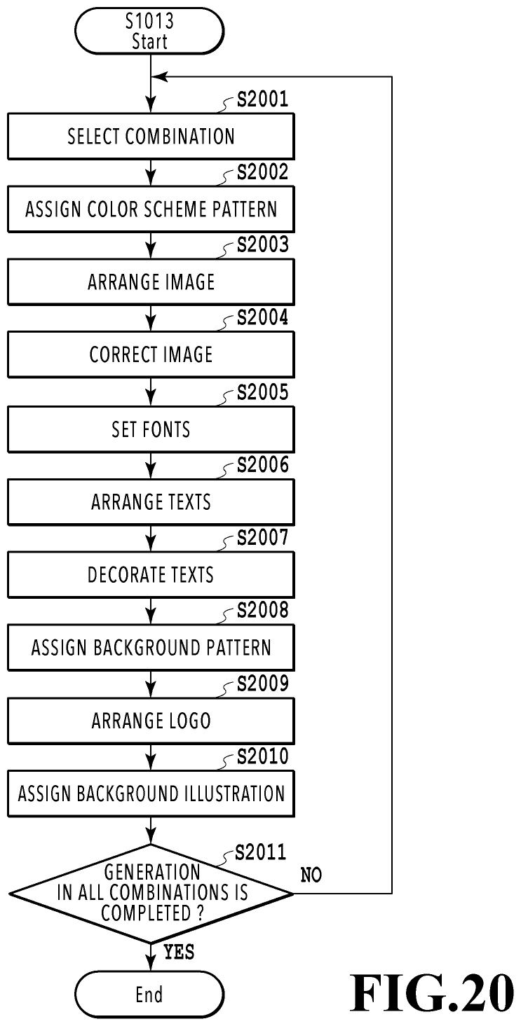

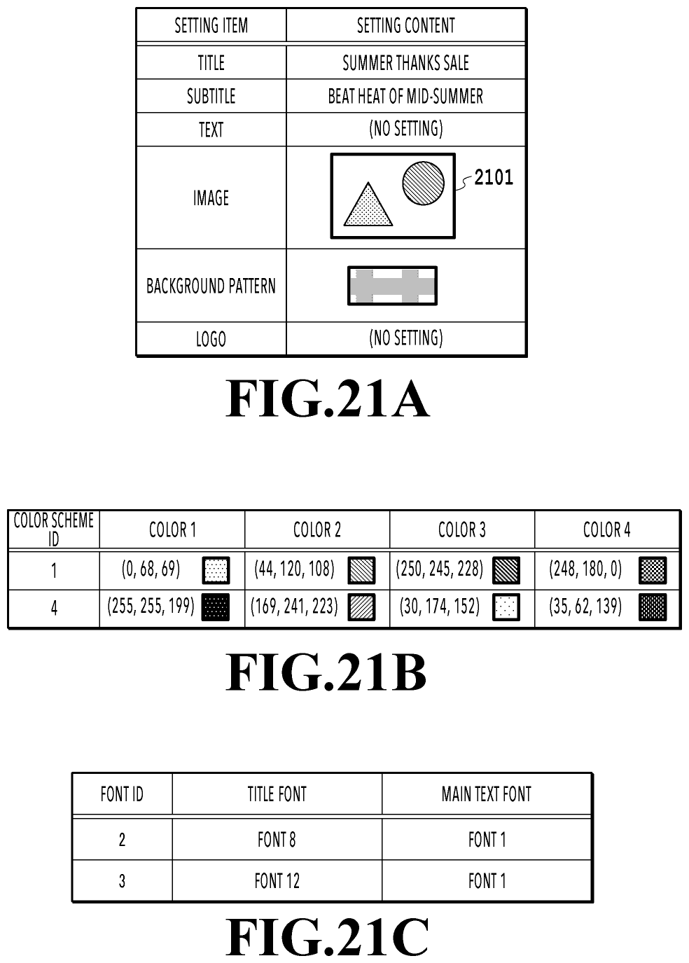

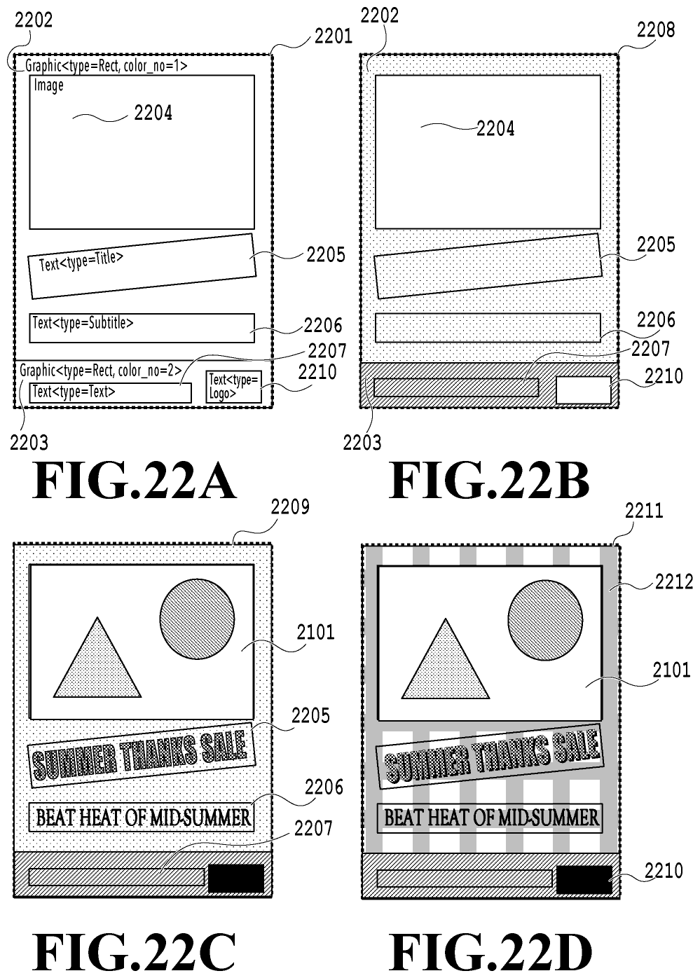

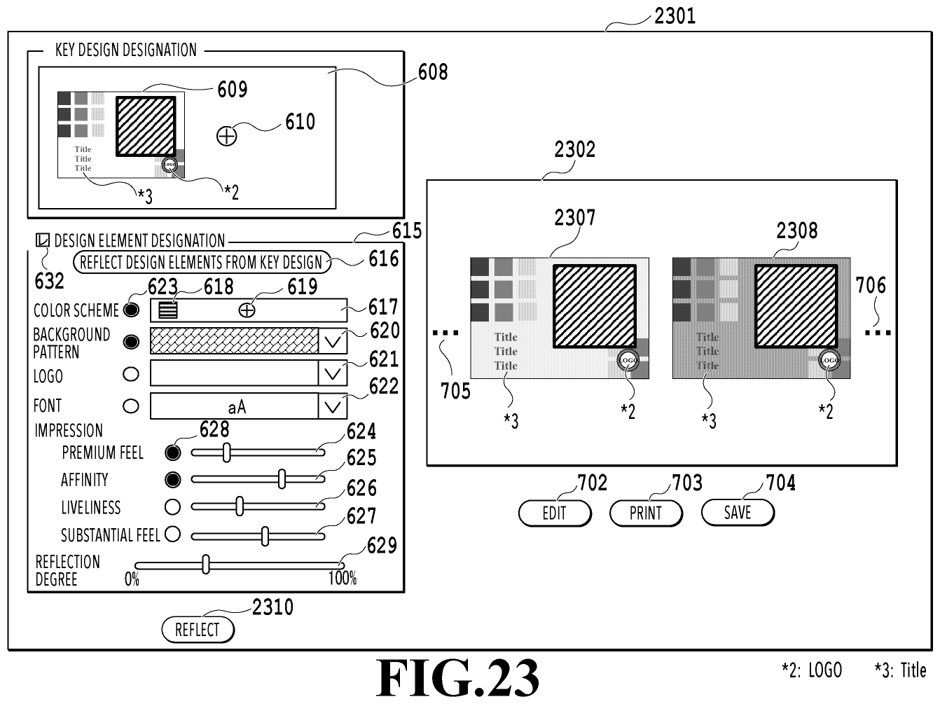

FIG. 20 is a flowchart explaining the layout process of S1013 in detail. Moreover, FIGS. 21A to 21C are diagrams explaining information inputted into the layout component 221. FIG. 21A is a table summarizing the character information, image data 2101, the background pattern, and the logo that are inputted. FIG. 21B is an example of a table illustrating the color scheme patterns obtained from the color scheme pattern selection component 217, and FIG. 21C is an example of a table illustrating the fonts obtained from the font selection component 220. FIGS. 22A to 22D are diagrams explaining a procedure of the process of the layout component 221.

First, the layout process is explained in detail by using FIG. 20. S2001 to S2011 are executed in S1013.

In S2001, the layout component 221 lists all combinations of the skeletons obtained from the skeleton selection component 216, the color scheme patterns obtained from the color scheme pattern selection component 217, the background patterns obtained from the background pattern scaling component 218, and the fonts obtained from the font selection component 220. The layout component 221 sequentially generates pieces of commercial product design data for the respective combinations by performing the following layout process. For example, in the case where: the number of obtained skeletons is three; the number of obtained color scheme patterns is two; the number of obtained background patterns is three; and the number of obtained fonts is two, 3×2×3×2=36 patterns of combinations are listed. The layout component 221 executes processes of S2002 to S2011 with one of the listed combinations being a target.

In S2002, the color scheme assigning component 1901 assigns the color scheme pattern obtained from the color scheme pattern selection component 217, to the skeleton obtained from the skeleton selection component 216. FIG. 22A is a diagram illustrating an example of the skeleton. In the present embodiment, explanation is given of an example in which a color scheme pattern with a color scheme ID of “1” in FIG. 21B is assigned to a skeleton 2201 in FIG. 22A. The skeleton 2201 in FIG. 22A is formed of two graphical objects 2202 and 2203, one image object 2204, three text objects 2205, 2206, and 2207, and a logo object 2210. First, the color scheme assigning component 1901 assigns a color to each of the graphical objects 2202 and 2203. Specifically, the color scheme assigning component 1901 assigns a corresponding color from the color scheme pattern, based on a color scheme number that is metadata described in the graphical object. Color “1” is assigned to the graphical object 2202, and Color “2” is assigned to the graphical object 2203. Next, the color scheme assigning component 1901 assigns, for example, the last color in the color scheme pattern to the text object (Text<type=Title>) whose metadata is type and whose attribute is “title” among the text objects. Specifically, in the present embodiment, Color 4 is assigned to the characters to be arranged in the text object 2205. Next, the color scheme assigning component 1901 sets a text color for characters to be arranged in each of the text objects 2206 and 2207 whose metadata is type and whose attributes are attributes other than “title” among the text objects, based on lightness of a background of the text object. In the present embodiment, the text color is set to white in the case where the lightness of the background of the text object is equal to or lower than a threshold, and is set to black if not. FIG. 22B is a diagram illustrating a state of a skeleton 2208 after execution of the color scheme assigning process described above. The color scheme assigning component 1901 outputs the skeleton data subjected to the color scheme assignment to the image arranging component 1902.

In S2003, the image arranging component 1902 arranges the image data obtained from the image analysis component 212 on the skeleton 2208 obtained from the color scheme assigning component 1901, based on analysis information associated with the image data. In the present embodiment, the image arranging component 1902 assigns the image data 2101 to the image object 2204 in the skeleton. Moreover, in the case where the aspect ratio of the image object 2204 varies from that of the image data 2101, the image arranging component 1902 crops the image data 2101 such that the aspect ratio of the image data 2101 matches the aspect ratio of the image object 2204. More specifically, the image arranging component 1902 crops the image data 2101 based on a position of an object obtained by analyzing the image data 2101 with the image analysis component 212 such that an object region reduced by the cropping is minimized. Note that the cropping method is not limited to this, and other cropping methods such as, for example, cropping a center portion of the image or adjusting a composition such that a face position forms a triangular composition may be used. The image arranging component 1902 outputs the skeleton data subjected to the image assignment to the image correcting component 1903.

In S2004, the image correcting component 1903 obtains the skeleton data subjected to the image assignment from the image arranging component 1902, and corrects the image arranged in the skeleton. In the present embodiment, in the case where the resolution of the image is insufficient, an up-sampling process by a super-resolution process is performed. First, the image correcting component 1903 determines whether the image arranged in the skeleton satisfies a certain resolution. For example, assume that an image of 1,600 px×1,200 px is assigned to a region of 200 mm×150 mm on the skeleton. In this case, the print resolution of the image can be calculated by using the formula (14).

$$\frac{1600}{200 \div 25.4} \approx 203 [ dpi ] \qquad ( 14 )$$

Next, in the case where the image correcting component 1903 determines that the print resolution of the image is lower than a threshold, the image correcting component 1903 improves the resolution by performing the super-resolution process. Meanwhile, in the case where the image correcting component 1903 determines that the print resolution of the image is equal to or higher than the threshold and the image has a sufficient resolution, no particular image correction is performed. In the present embodiment, the super-resolution process is performed in the case where the print resolution of the image is lower than 300 dpi.

In S2005, the font setting component 1904 sets the fonts obtained from the font selection component 220 for the skeleton data obtained from the image correcting component 1903 and subjected to the image correction. FIG. 21C is an example of the combinations of fonts selected by the font selection component 220. In the present embodiment, explanation is given of an example of font assignment in the case where the fonts assigned to the skeleton data subjected to the image correction are fonts of font ID “2” in FIG. 21C. In the present embodiment, the fonts are set for the text objects 2205, 2206, and 2207 in the skeleton 2209. Note that, in the case where the commercial product is the poster, a font that stands out is set for the title from the viewpoint of noticeability, and a font that is easily readable is set for characters other than the title from the viewpoint of viewability in many cases. Accordingly, in the case where the commercial product to be created is the poster, the font selection component 220 selects two types of fonts that are a title font and a main text font. The font setting component 1904 sets the title font for the text object 2205 whose attribute is “title”, and sets the main text font for the other text objects 2206 and 2207. The font setting component 1904 outputs the skeleton data subjected to the font setting to the text arranging component 1905. Note that, although the font selection component 220 selects two types of fonts in the present embodiment, the present disclosure is not limited to this, and for example, only the title font may be selected. In this case, the font setting component 1904 uses a font corresponding to the title font as the main text font. Specifically, the main text font matching the type of the title font may be set as follows: for example, in the case where a font of a Gothic family is used for the title, a typical Gothic font with high readability is selected for the other text objects, and in the case where a font of a Ming family is used for the title, a typical Ming font is selected for the other text objects. As a matter of course, the title font and the main text font may be identical. Moreover, different fonts may be used as follows depending on a degree at which the text objects are desired to be made noticeable: for example, the title font is used for the text objects of the title and the subtitle while the main text font is used for the other text objects; or the title font is used for characters of a certain font size or larger.

In S2006, the text arranging component 1905 arranges the texts designated in the text designation component 202, in the skeleton 2209 obtained from the font setting component 1904 and subjected to the font setting. In the present embodiment, texts illustrated in FIG. 21A are assigned with reference to the attributes of metadata of the text objects in the skeleton 2209. Specifically, “Summer Thanks Sale” whose attribute is title is assigned to the text object 2205, and “Beat Heat of Mid-Summer” whose attribute is subtitle is assigned to the text object 2206. Since no main text is set, nothing is assigned to the text object 2207. FIG. 22C illustrates the skeleton 2209 that is an example of skeleton data after the process by the text arranging component 1905. The text arranging component 1905 outputs the skeleton 2209 subjected to the text arrangement to the text decorating component 1906.

In S2007, the text decorating component 1906 decorates the text objects in the skeleton 2209 obtained from the text arranging component 1905 and subjected to the text arrangement. In the present embodiment, in the case where a color difference between the title character and a background region of the title character is equal to or less than a threshold, a process of adding an outline to the title character is performed. This improves the readability of the title. The text decorating component 1906 outputs the decorated skeleton to the background pattern setting component 1907.

In S2008, the background pattern setting component 1907 sets the background pattern in a graphical object determined to be the background region in the skeleton 2209 obtained from the text decorating component 1906 and subjected to the text decoration. The graphical object determined to be the background region is the graphical object whose color scheme number is “1”. In FIGS. 22A to 22D, the graphical object 2202 is determined to be the background region, and the background pattern setting component 1907 sets the background pattern in the graphical object 2202. In the setting of the background pattern, some of the colors in the background pattern are changed to the color scheme assigned in the color scheme assigning component 1901, and then a background pattern 2212 is set in the graphical object 2202 that is the background region. FIG. 22D is an example of a skeleton 2211 subjected to the background pattern setting. The background pattern setting component 1907 outputs the skeleton 2211 for which the background pattern 2212 is set, to the logo arranging component 1908.

In S2009, the logo arranging component 1908 arranges a logo in the logo object 2210 in the skeleton 2211 obtained from the background pattern setting component 1907 and subjected to the background pattern installation. FIG. 22D is an example of the skeleton subjected to the logo arrangement. In the case where no logo is set in the creation condition designation component 201, S2009 is skipped. The logo arranging component 1908 outputs data of the skeleton 2211 in which the logo is arranged, to the background illustration setting component 1909.

In S2010, the background illustration setting component 1909 arranges a background illustration in a background region of the skeleton 2211 obtained from the logo arranging component 1908 and subjected to the logo installation. The background illustration is, for example, an illustration designated in the image designation region 605 of the application launch screen 601, and is obtained by the image obtaining component 211. In the case where no background illustration is set, S2010 is skipped. The background illustration setting component 1909 outputs data of the skeleton in which the background illustration is arranged, that is data of the skeleton for which the layout is completely finished, to the impression estimation component 222 as the commercial product data.

In S2011, the layout component 221 determines whether the commercial product data is generated in all combinations for the type of commercial product set as the processing target. In the case where the layout component 221 determines that the commercial product data in which the background pattern, the logo, and the background illustration are arranged is generated in all of the combinations of the skeletons, the color scheme patterns, and the fonts, the layout component 221 terminates the layout process, and transitions to S1014. In the case where the layout component 221 determines that the commercial product data is not generated for all combinations, the process returns to S2001, and the commercial product data is generated in a combination in which the commercial product data is not generated yet. That is the explanation of S1013. Description returns to the explanation of FIG. 10A.

In S1014, the impression estimation component 222 executes a rendering process on each of the multiple pieces of commercial product data generated in S1013 and obtained from the layout component 221, and estimates an impression of each of the rendered commercial product images. Then, the impression estimation component 222 associates the estimated impression with the commercial product data. Note that the rendering process is a process of converting the commercial product data to the image data. For example, even in commercial products with the same color scheme pattern, the arrangement varies in the case where the skeleton varies. Accordingly, an area in which each color is actually used varies. Thus, it is necessary to evaluate not only the tendency of the impression of each of the color scheme pattern and the skeleton but also the impression of the final commercial product. Accordingly, the present process is executed at this timing. This allows evaluation of not only the impression of each of the elements in the commercial product such as the color scheme and the arrangement but also the impression of the final commercial product in which the image and the characters are included and laid out.

In S1015, the commercial product creation application determines whether pieces of commercial product data as many as the creation number set for each commercial product type are generated or not. The creation number is determined in S1005. In the present embodiment, the creation number is five. In the case where pieces of commercial product data as many as the creation number are not generated, the process returns to S1009, and new commercial product data is generated. In the case where pieces of commercial product data as many as the creation number are generated, the process transitions to S1016.

In S1016, the commercial product creation application determines whether the generation of the commercial product data is completed for all commercial product types. In the present embodiment, the setting is such that five pieces of commercial product data are generated for each of the two commercial product types of the postcard and the flyer. Specifically, ten pieces of commercial product data are generated. In the case where the generation of pieces of commercial product data as many as the creation number is not completed for all commercial product types, the commercial product creation application changes the commercial product type being the generation target, returns to S1008, and executes the process of generating pieces of commercial product data as many as the creation number for the newly-set commercial product type. In the case where the generation of commercial product data as many as the creation number is completed for all commercial product types, the process transitions to S1017.

In S1017, the commercial product selection component 223 selects a commercial product set to be outputted to the display 105, based on the estimated impressions of the respective commercial product images obtained from the impression estimation component 222. Specifically, the commercial product selection component 223 first determines a distance (impression distance) between the target impression and the estimated impression associated with each piece of commercial product data. The determined impression distance is saved in association with the commercial product data. Since ten pieces of commercial product data are generated in the present embodiment, the commercial product selection component 223 determines the impression distances for the respective ten pieces of commercial product data. Note that a Euclidean distance is used as the impression distance. The smaller the value indicated by the Euclidean distance is, the closer the estimated impression is to the target impression. Note that the distance determined by the commercial product selection component 223 is not limited to the Euclidean distance, and may be a Manhattan distance, a Cosine similarity, or the like as long as a distance between vectors can be determined.

Next, the commercial product selection component 223 determines a total impression distance for each commercial product set. The total impression distance is a sum of the impression distances of all pieces of commercial product data included in the commercial product set. For example, in the case where one commercial product set includes one piece of commercial product data for each of the two types of commercial products of the flyer and the postcard, the total impression distance is determined by adding up the impression distances estimated for the respective two types of commercial product data. The determined total impression distance is saved in the HDD 104 in association with the commercial product set. Since the total impression distance of the commercial product set is evaluated, the impressions of commercial products spreading across multiple types as a whole can be brought closer to the intended target impression. Next, the commercial product selection component 223 selects the commercial product sets based on the total impression distances associated with the respective commercial product sets. The number of commercial product sets to be selected is determined based on, for example, a display number in the preview screen 701. Specifically, in a setting in which one commercial product set is displayed, the commercial product selection component 223 selects the commercial product set with the smallest total impression distance. Meanwhile, in a setting in which multiple commercial product sets are displayed as in the preview screen 701C, the commercial product selection component 223 selects commercial product sets as many as the number of display sets to be displayed, in ascending order of the total impression distance. Moreover, the commercial product selection component 223 may limit the commercial product sets to be display on the preview screen to commercial product sets whose total impression distances are equal to or less than a predetermined threshold. If the number of commercial product sets is less than the number of sets to be displayed on the preview screen in this case, the process may return to S1008 to further generate other pieces of commercial product data.

In S1018, the generated commercial product display component 206 displays the preview screen 701 of FIGS. 7A to 7D. Specifically, the commercial product data included in the commercial product set selected by the commercial product selection component 223 in S1017 is rendered, and the commercial product images are outputted to the display 105. That is the explanation of the commercial product generation process in which other commercial products are generated from the key design designated by the user.

As explained above, according to present embodiment, the commercial product generation apparatus 100 can generate data of commercial products with feeling of uniformness with the key design that suitably expresses the impression of the brand. Particularly, in the present embodiment, in the case where the background pattern used in the key design is assigned to a commercial product with a size different from the size of the key design, the scaling ratio of the background pattern is limited to the above-mentioned specific range. This can suppress feeling of strangeness in appearance of the background pattern caused by the variation in commercial product size, and enable creation of commercial products with feeling of uniformness across all commercial product types. Moreover, the commercial product generation apparatus 100 selects the commercial product set whose total impression distance is smaller than the threshold, that is close to the target impression, from among multiple candidates of the commercial product set. Accordingly, it is possible to generate a commercial product set in which not only the impression of each design element but also the impression of the commercial product set as whole are close to the target impression.

### Modified Example of First Embodiment

Another example of the preview screen is explained as a modified example of the first embodiment. In the preview screen of this example, the generated commercial product images are displayed and settings of the design elements and settings of the key design are received.

FIG. 23 is a diagram illustrating a preview screen 2301 in the modified example of the first embodiment. The preview screen 2301 illustrated in FIG. 23 includes the key design designation region 608, the design element designation region 615, a preview region 2302, the edit button 702, the print button 703, the save button 704, and a reflection button 2310. Note that parts denoted by the same reference numerals as those in the application launch screen 601 of FIG. 6 operate as in FIG. 6. Moreover, parts denoted by the same reference numeral as those in the preview screen 701 of FIGS. 7A to 7D operate as in FIGS. 7A to 7D. Operations of the key design designation region 608 and the design element designation region 615 in the preview screen 2301 are the same as those of the key design designation region 608 and the design element designation region 615 illustrated in FIG. 6. Moreover, operations of the edit button 702, the print button 703, the save button 704, the previous candidate display button 705, and the next candidate display button 706 are the same as those in the preview screen 701 of FIGS. 7A to 7D. The generated commercial product display component 206 displays the preview screen 2301 in S1018.

The key design designation region 608 is a UI that receives designation of the key design to be used in the commercial product creation. The thumbnail 609 of the designated key design is displayed in the key design designation region 608. The key design addition button 610 is displayed in the key design designation region 608.

The design element designation region 615 is an UI that receives designation of a design element by the user for each design element. The design element designation region 615 includes the color scheme designation box 617, the background pattern designation box 620, the logo designation box 621, the impression sliders (impression slider bars or impression setting sliders) 624 to 627, and the reflection degree slider 629. Moreover, the design element designation region 615 is provided with the radio buttons 623 for controlling enabling and disabling of settings of the respective design elements, the radio buttons 628 for controlling enabling and disabling of the respective impression factors, the check box 632 for enabling the settings in the design element designation region 615, and the like.

The reflection button 2310 is operated in the case where the information designated in the key design designation region 608 and the design element designation region 615 in the preview screen 2301 is to be reflected.

The commercial product generation process illustrated in FIG. 10A is executed, and in S1018, generated commercial product images 2307 and 2308 are displayed in the preview region 2302 of the preview screen 2301 in FIG. 23. In the preview screen 2301 of the present modified example, changes of the design elements and the key design are received in a state where the commercial product images 2307 and 2308 are displayed. The user performs operations in the key design designation region 608 and the design element designation region 615, and changes the design elements and the key design while checking the commercial product images 2307 and 2308 displayed in the preview region 2302. The process proceeds to S1002 in the case where the reflection button 2310 is pressed. The commercial product generation component 210 executes the processes of S1002 to S1018 by using the changed design elements and the changed key design. As a result, commercial product images in which the settings of the key design and the design elements set on the preview screen 2301 are reflected are created, and the generated commercial product display component 206 displays the commercial product images on the preview screen 2301.

The user can thereby perform the setting of the key design and the setting of the design elements while checking the generation result of the commercial product data. This eliminates the need of performing cumbersome operations of returning to the application launch screen 601 again after the preview display and recreating the commercial products in different setting contents. The user can efficiently obtain multiple pieces of commercial product data having a uniform design.

### Second Embodiment

In the first embodiment, explanation is given of the example in which the commercial product creation application determines the skeletons, the color schemes, the background patterns, and the fonts matching the target impression, based on the contents, the key design, the design elements including the target impression designated by the user, and the like, and creates the commercial products. A commercial product creation application of the second embodiment includes a combination generation component 2402. The combination generation component 2402 searches for combinations of constituent elements in which the impressions of the commercial products as a whole are close to the target impression, based on a genetic algorithm. The commercial product creation application thereby generates suitable commercial products matching the target impression more flexibly without preliminary processes such as the creation of the skeleton impression table, the creation of the color scheme pattern impression table, and the creation of the font impression table.

### <Software Block Diagram>

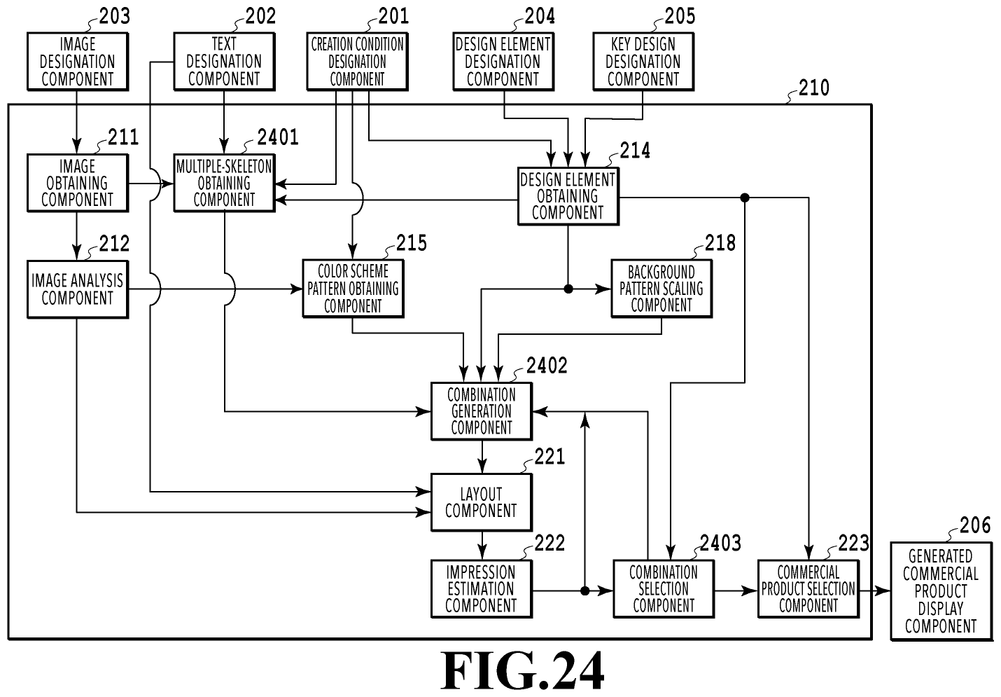

FIG. 24 is a software block diagram of the commercial product creation application in the second embodiment. As illustrated in FIG. 24, the commercial product creation application in the second embodiment includes the creation condition designation component 201, the text designation component 202, the image designation component 203, the design element designation component 204, the key design designation component 205, the generated commercial product display component 206, and the commercial product generation component 210. The commercial product generation component 210 includes the image obtaining component 211, the image analysis component 212, a multiple-skeleton obtaining component 2401, the design element obtaining component 214, the color scheme pattern obtaining component 215, the background pattern scaling component 218, the combination generation component 2402, the layout component 221, the impression estimation component 222, a combination selection component 2403, and the commercial product selection component 223.

The commercial product generation component 210 is different from the commercial product generation component 210 of the first embodiment in that the commercial product generation component 210 includes the combination generation component 2402 and the combination selection component 2403 instead of the skeleton selection component 216, the color scheme pattern selection component 217, the logo selection component 219, and the font selection component 220 in FIG. 2. Moreover, the commercial product generation component 210 includes the multiple-skeleton obtaining component 2401 instead of the skeleton obtaining component 213. Since configurations of FIG. 24 denoted by the same reference numerals as those in FIG. 2 are the same as the configurations in the first embodiment, explanation thereof is omitted.

The multiple-skeleton obtaining component 2401 obtains skeletons for the commercial product types designated in the creation condition designation component 201. All skeletons for the designated commercial product types are obtained and saved in the RAM 103, for use of a search algorithm.

The combination generation component 2402 obtains one or more skeletons for the commercial product types, from the multiple-skeleton obtaining component 2401. Moreover, the combination generation component 2402 obtains the commercial product estimated impression associated with the generated commercial product data, from the impression estimation component 222. Furthermore, the combination generation component 2402 obtains the target impression from the design element obtaining component 214, and obtains the scaled background pattern from the background pattern scaling component 218. Moreover, the combination generation component 2402 obtains the color scheme pattern list, the font list, and the logo list, from the HDD 104. The combination generation component 2402 generates combinations of the constituent elements of commercial product (skeleton, color scheme pattern, and font) and the design elements (logo and background pattern) to be used in the commercial product generation, for the commercial product types. As an example, in the present embodiment, combinations of two types of commercial products of the postcard and the flyer are generated. Each of the combinations of these commercial product types is defined as the commercial product set. The combination generation component 2402 outputs the generated commercial product sets as many as the number of created sets, to the layout component 221. The generation of the combinations is described later.

The combination selection component 2403 selects the commercial product sets close to the target impression, from among the multiple commercial product sets generated in the multiple combinations generated by the combination generation component 2402, and saves the selected commercial product set in the RAM 103. Specifically, the combination selection component 2403 selects the commercial product sets in which a value of an impression distance between an estimated impression and the target impression obtained from the design element obtaining component 214 is equal to or less than a threshold, and saves the selected commercial product sets in the RAM 103, the estimated impression being an impression estimated by the impression estimation component 222 for each of the multiple generated commercial product sets. The combination selection component 2403 determines whether the number of selected and saved commercial product sets has reached a predetermined creation number, and repeats the generation of the combinations and the selection of the commercial product sets until the number of selected and saved commercial product sets reaches the predetermined creation number. The predetermined creation number may be a number set in advance, or a number designated by the user. The commercial product selection component 223 outputs data of the selected commercial product sets to the generated commercial product display component 206.

### <Commercial Product Generation Process>

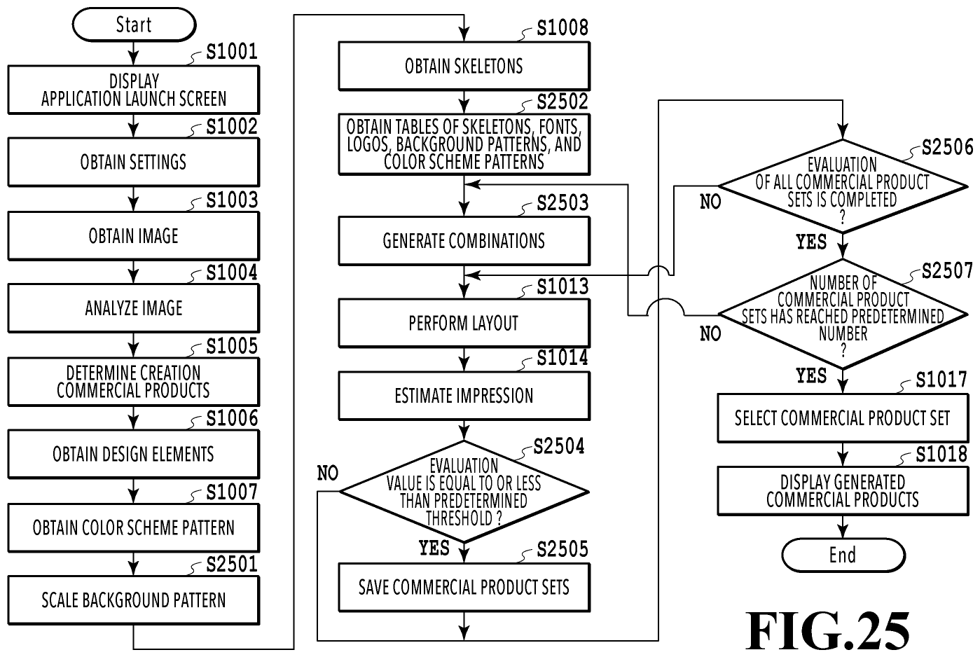

FIG. 25 is a flowchart illustrating a commercial product generation process executed by the commercial product generation component 210 of the commercial product creation application in the second embodiment. The process illustrated in the present flowchart is started in the case where the user presses the launch icon of the commercial product creation application as in the first embodiment. Note that, since processes in FIG. 25 denoted by the same reference numerals as those in FIGS. 10A to 10D (commercial product generation process of the first embodiment) are the same as the processes in the first embodiment, explanation thereof is omitted. Moreover, in the commercial product generation process of the second embodiment illustrated in the present flowchart, S1010 (color scheme pattern selection) and S1012 (font/logo selection) illustrated in FIG. 10A are omitted. S2502 (commercial product set table generation) and S2503 (combination generation) are added after S1007 (skeleton obtaining). Furthermore, determination of evaluation values and completion determination (S2504 to S2507) are added after the impression estimation process of S1014. Moreover, a background pattern scaling process (S2501) is performed after the obtaining of the color scheme pattern in S1007. Points different from the first embodiment are mainly explained below.

In S1001 to S1007, the commercial product creation application obtains the settings in the application launch screen 601. Specifically, the commercial product creation application obtains the settings of the types of the creation commercial products, the category, the contents (character information and image), the design elements (color scheme, background pattern, logo, font, and target impression), the reflection degree of the design elements, and the key design. The image obtaining component 211 obtains the designated image data. The image analysis component 212 analyzes the obtained image data, and obtains the feature amount of the image and the main color of the image. The commercial product generation component 210 determines the types of commercial products to be created and the creation number for each commercial product type. The design element obtaining component 214 extracts the design elements from the key design designated in the key design designation component 205, as the design elements to be used in the commercial product creation. The color scheme pattern obtaining component 215 obtains the color scheme pattern to be used in the commercial product creation.

In S2501, the background pattern scaling component 218 enlarges or reduces the background pattern obtained by the design element obtaining component 214 for each size or type of the creation commercial product. The process of the background pattern scaling component 218 is the same as that in the first embodiment. The scaled background pattern is outputted to the layout component 221 in association with the commercial product.

Next, the process proceeds to S1008. The multiple-skeleton obtaining component 2401 obtains skeletons for the commercial product types designated in the creation condition designation component 201. Specifically, the processes of S1031 to S1037 in FIG. 10C are repeated for the designated commercial product types. All skeletons for the designated commercial product types are obtained for use of the search algorithm. For example, in the case where postcard and flyer are set as the creation commercial products in the application launch screen 601 of FIG. 6, the multiple-skeleton obtaining component 2401 obtains all skeletons created for the postcard and the flyer.

Processes of S2502, S2503, S1013, S1014, and S2504 to S2506 are a loop process repeated as many times as the creation number of commercial products. In the following explanation, an initial operation and operations of second loop and beyond are separately explained.

In S2502 of the initial operation, the combination generation component 2402 obtains the tables of skeletons, color schemes, fonts, logos, and background patterns that are to be used in the commercial product generation.

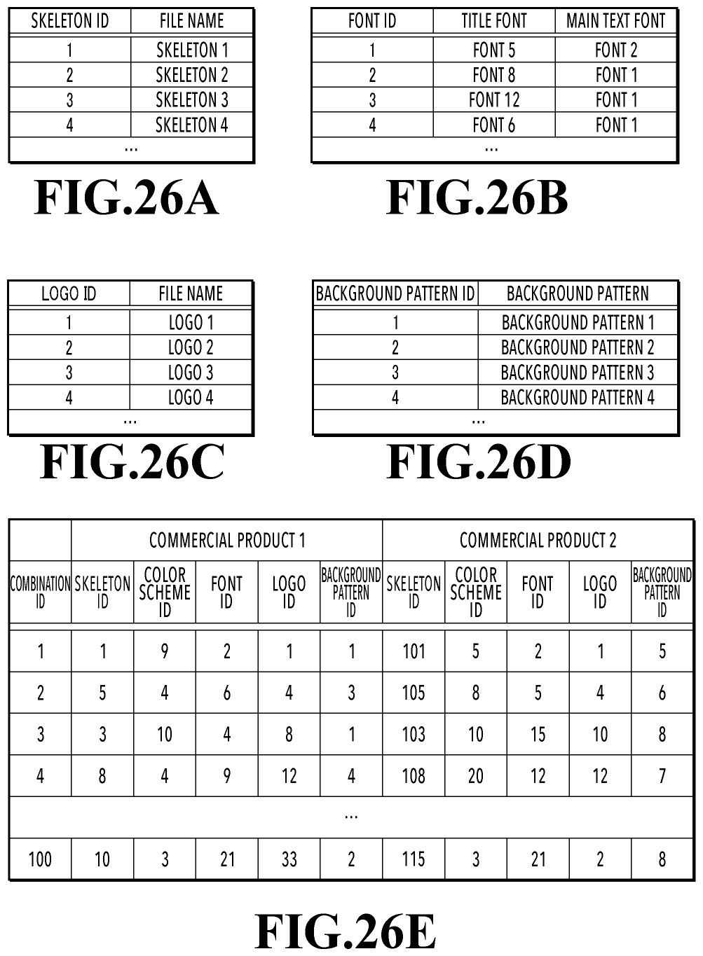

The tables used by the combination generation component 2402 are explained by using FIGS. 26A to 26E. FIG. 26A illustrates a list of skeletons obtained from the multiple-skeleton obtaining component 2401 by the combination generation component 2402. FIG. 26B illustrates a list of fonts obtained from the design element obtaining component 214 by the combination generation component 2402. FIG. 26C illustrates a list of logos obtained from the design element obtaining component 214 by the combination generation component 2402. FIG. 26D illustrates a list of background patterns obtained from the background pattern scaling component 218 by the combination generation component 2402. Moreover, the combination generation component 2402 obtains the color scheme patterns (FIG. 5) obtained by the color scheme pattern obtaining component 215. Although four design elements and four IDs are illustrated in each of the tables of FIG. 5 and FIGS. 26A to 26D, the numbers of design elements and IDs may be any numbers. In the following explanation, as an example, 115 skeleton IDs, 20 color scheme IDs, 21 font IDs, 35 logo IDs, and 8 background pattern IDs are assumed to be obtained.

In S2503, the combination generation component 2402 randomly generates combinations from the above-mentioned five tables. These combinations are generated for each of the designated commercial product types. In the present embodiment, 100 combinations are generated for each of the commercial product 1 and the commercial product 2 in the commercial product set. FIG. 26E illustrates a commercial product set table generated in the present embodiment.

In the case where design elements to be common between the commercial products are designated in the design element designation component 204, the combination generation component 2402 generates the combinations such that the design elements have the same IDs between the commercial products. Moreover, since the commercial product 1 and the commercial product 2 vary in type and thus vary in commercial product size and estimated viewing distance, the background pattern scaling component determines different scaling ratios for the commercial product 1 and the commercial product 2. In other words, the scaling ratio of the background pattern of the commercial product 1 is different from that of the commercial product 2. In FIG. 26E, the background pattern IDs 1 to 4 are set for the commercial product 1, and background pattern IDs 5 to 8 are set for the commercial product 2. Moreover, in the case where the reflection degree is designated in the design element designation component 204, a percentage in which the IDs are the same between the commercial product 1 and the commercial product 2 is determined based on the setting value of the reflection degree. Specifically, in the case where the reflection degree of the design elements is designated to be 0.3 (30%), the IDs are the same between different types in 30 out of 100 combinations, and remaining 70 combinations are the random combinations.

Then, the combination generation component 2402 executes the layout (S1013), the impression estimation (S1014), and the determination of the impression value (S2504) on each of the commercial product sets of all generated combinations. The impression estimation can be performed by causing the deep learning model for impression estimation expanded on the RAM 103 to operate in the CPU 101 or the GPU 109 as in the first embodiment. Note that the impression estimation is not limited to deep learning, and for example, in the case where a machine learning method such as decision tree is used, there may be created a machine learning model that extracts feature amounts such as a lightness average value, an edge amount, and the like of each commercial product image by performing image analysis and that estimates the impression based on these feature amounts.

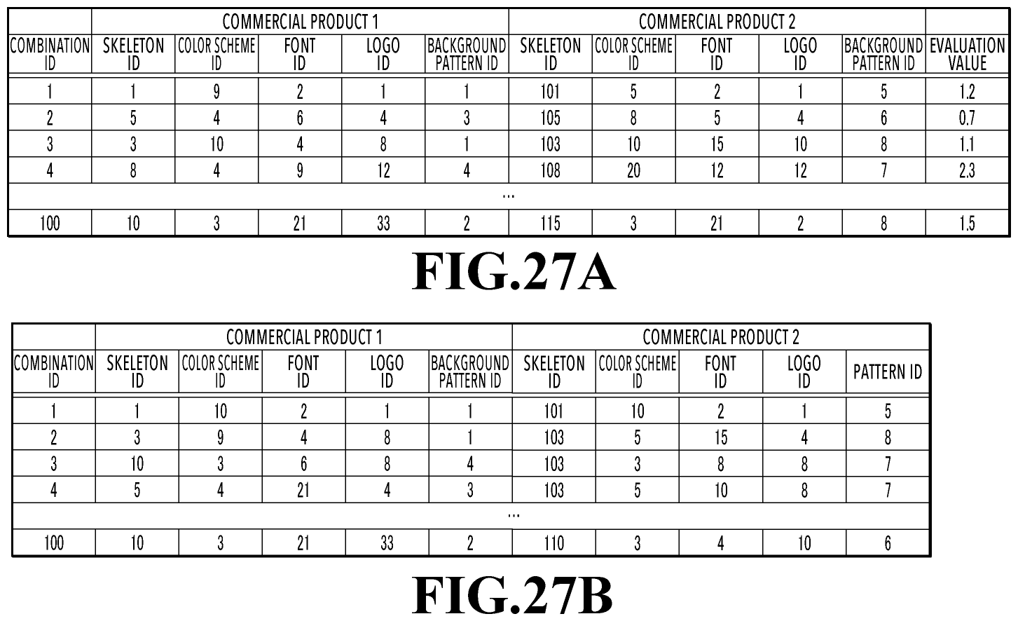

In S2504, the combination selection component 2403 determines an evaluation value for each commercial product set from the estimated impressions obtained from the impression estimation component 222, and associates the evaluation value with each commercial product set in the commercial product set table. The evaluation value is assumed to be the total impression distance explained in the first embodiment. FIG. 27A is a table in which the evaluation value is associated with each line of the commercial product set table illustrated in FIG. 26E. The column of evaluation value in FIG. 27A illustrates the evaluation value of each commercial product set generated in the combination of the corresponding line. In S2503, the combination selection component 2403 determines whether the evaluation value of the total impression distance is equal to or less than a predetermined threshold. The commercial product set whose evaluation value of the total impression distance is equal to or less than the predetermined threshold is saved in the RAM 103 in S2505, and the process proceeds to S2506. If not, S2505 is skipped, and the process proceeds to S2506.

In S2506, the combination selection component 2403 determines whether the determination of the total impression distance is completed for all commercial product sets in the commercial product set table. In the case where the determination of the total impression distance is completed for all commercial product sets, the process proceeds to S2507. If not, the process returns to S2504.

In S2507, the combination selection component 2403 determines whether the number of commercial product sets saved in the RAM 103 has reached a predetermined creation number. In the case where the number has reached the predetermined creation number, the process proceeds to S1017. In the case where the number has not reached the predetermined creation number, the process returns to S2503.

In S2503 of the second loop and beyond, the combination generation component 2402 generates a commercial product set table in new combinations, from the commercial product set table of FIG. 27A. FIG. 27B is a newly-generated commercial product set table. In the present embodiment, new combinations are assumed to be generated by using tournament selection and uniform crossover in a genetic algorithm. The combination generation component 2402 first randomly selects N combinations from the table of FIG. 27A. In this case, for example, N=3. Next, top two combinations in ascending order of the evaluation value (=close to target impression and have high design similarities) are selected from among the selected combinations. Lastly, new combinations are generated by randomly interchanging the combination elements (skeleton IDs, color scheme IDs, font IDs, logo IDs, and background pattern IDs) in the two selected combinations. For example, the combination IDs 1 and 2 in FIG. 27B illustrate results generated from the combination IDs 1 and 3 in FIG. 27A, and the color scheme IDs are interchanged in this example. FIG. 27B illustrates 100 new combinations generated by repeating the above-mentioned procedure.

The commercial product creation application can thereby set the total impression distance, that is the sum of the distances between the target impression and the impressions estimated from the respective commercial products in the commercial product set, as the evaluation value, and efficiently search for the combinations based on the evaluation values. Note that, although 100 combinations are generated in the present embodiment, the number of combinations to be generated is not limited to this. Moreover, although the tournament selection and the uniform crossover are used, the present disclosure is not limited to this, and other methods such as, for example, ranking selection, roulette selection, and one-point crossover may be used. Furthermore, mutation may be incorporated to make the combination generation less likely to fall into local optimal solution. Moreover, although the skeleton (arrangement), the color scheme pattern, the font, the logo, and the background pattern are used as the constituent elements of the commercial products to be searched, other constituent elements may be used. Increasing the constituent elements to be searched enables generation of commercial products of greater variations, and can increase a range of impression representation.

In S2504 of the second loop and beyond, the combination selection component 2403 determines the evaluation value of the total impression distance for each commercial product set in the new commercial product set table, and associates the evaluation value with each commercial product set in the commercial product set table as in S2503 of the first loop. In S2505, the combination selection component 2403 saves the commercial product sets whose evaluation values of the total impression distances are equal to or less than the predetermined threshold, in the RAM 103.

S2506 to S2507 are also the same as those in the first loop.

In S2507, the combination selection component 2403 determines whether the commercial product sets saved in the RAM 103 has reached the predetermined creation number. In the case where the number has reached the predetermined creation number, the process proceeds to S1017.

Note that, in the case where the number of saved commercial product sets whose evaluation values are equal to or less than the threshold is more than the predetermined creation number, the combination selection component 2403 may compare the evaluation values of the respective saved commercial product sets, keep the commercial product sets with smaller evaluation values in the RAM 103, and set the kept commercial product sets as the final evaluation result. In this case, the commercial product sets determined to have larger evaluation values based on the comparison result may be deleted from the RAM 103. Moreover, although the combination searching is performed by using the genetic algorithm in the present embodiment, the searching method is not limited to this, and other searching methods such as a neighborhood searching method and a tabu searching method may be used.

In S1017, the commercial product selection component 223 selects the commercial product sets to be outputted to the display 105 (to be presented to the user) based on the estimated impressions of the respective commercial product images obtained from the impression estimation component 222 as in the first embodiment. In S1018, the generated commercial product display component 206 displays the preview screen 701. Note that, as illustrated in FIG. 23, the preview screen 701 may include the key design designation region 608 and the design element designation region 615.

As explained above, according to the second embodiment, the combinations of the constituent elements and the design elements to be used in the commercial products are automatically generated, and the commercial products generated based on the combinations are evaluated based on the target impression to generate the commercial product sets. The commercial product sets that are close to the target impression and that have designs with uniform feel can be thereby generated. This method is particularly effective in the case where the commercial product set is generated in response to the image and the character information inputted by the user. For example, explanation is given of the case where the image designated by the user gives an impression of liveliness, but the user desires to generate a commercial product set that gives a calm impression as a whole. According to the process of the second embodiment, the commercial product creation application estimates the impression of the commercial products as a whole, and searches for the combinations of the skeletons, the color scheme patterns, the fonts, the logos, and the background patterns that are close to the target impression and that have high design similarities. To this end, the combination selection component 2403 of the commercial product creation application selects commercial products using skeletons with small image areas or commercial products in which impressions of the fonts and the color schemes are calmer to suppress the impression given by the image. Specifically, the constituent elements used in the commercial products are controlled in response to the image designated by the user. Moreover, in the case where the impression intended by the user and the impression given by the key design vary from each other, the combination selection component 2403 of the commercial product creation application selectively uses skeletons in which the arrangement area of the key design is small. Accordingly, in the second embodiment, it is possible to flexibly find combinations of design elements with feeling of uniformness and constituent elements suitable for the impression of the commercial product set as a whole. This allows the commercial product sets with uniform design to be created in many variations, and as a result, commercial product sets that are close to the target impression and that have uniform design can be created.

Although the embodiments of the present disclosure have been explained above with reference to the attached drawings, the present disclosure is not limited to these examples. For example, the scaling of the background pattern by the background pattern scaling component 218 may be determined in methods other than the determination using the formulae described as examples. For example, the scaling ratio may be determined in advance for each of combinations of a commercial product being a source (key design) and a commercial product being a destination. Moreover, a suitable scaling ratio may be determined for each background pattern, and held in association with the background pattern. Moreover, it is apparent that those skilled in the art can come up with various change examples or modification examples within the scope of the disclosed technical idea, and these change examples and modification examples are understood to also belong to the technical scope of the present disclosure as a matter of course.

The above-mentioned embodiments are also implemented by executing the following process. Specifically, this process is a process in which software (program) that implements the functions of the above-mentioned embodiments is supplied to a system or an apparatus via a network or various storage media, and a computer (CPU, MPU, or the like) of the system or the apparatus reads out and executes the program. Moreover, the program may be executed by one computer or executed by causing multiple computers to operate together. Furthermore, not all of the processes described above have to be implemented by software, and some or all of the processes may be implemented by hardware such as an ASIC. Moreover, the CPU is not limited to a configuration in which one CPU performs all processes, and may be such that multiple CPUs perform the processes while cooperating with each other as necessary. Moreover, the functions of the above-mentioned embodiments may be implemented by methods other than the execution of the read program codes by the computer. The implementation of the functions of the above-mentioned embodiments also includes a case where an OS or the like operating on the computer performs some or all of the actual processes based on instructions of these program codes, and the functions of the above-mentioned embodiments are implemented by these processes.

According to the present disclosure, it is possible generate creation product data by which impressions of multiple creation products are brought closer to each other.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-153373, filed Sep. 5, 2024, which is hereby incorporated by reference herein in its entirety.

What is claimed is:

1. An information processing apparatus configured to generate creation product data, the information processing apparatus comprising:
one or more memories; and
one or more processors storing instructions to cause the one or more processors to function as a generation unit configured to generate second creation product data including background information of first creation product data and varying from the first creation product data at least in size, wherein
the generation unit generates background information of the second creation product data by enlarging or reducing the background information of the first creation product data such that a size ratio between the background information of the first creation product data and the background information of the second creation product data takes a value between 1 and a ratio between a size of the first creation product data and a size of the second creation product data,
in a case where the size of the second creation product data is smaller than the size of the first creation product data, a size of the background information of the second creation product data is smaller than a size of the background information of the first creation product data, and is larger than a size of the background information of the first creation product data that is reduced by the ratio of the size of the second creation product data to the size of the first creation product data, and
in a case where the size of the second creation product data is larger than the size of the first creation product data, the size of the background information of the second creation product data is larger than the size of the background information of the first creation product data, and is smaller than a size of the background information of the first creation product data that is enlarged by the ratio of the size of the second creation product data to the size of the first creation product data.

2. The information processing apparatus according to claim 1, wherein the generation unit determines a ratio of the enlargement or the reduction also based on a ratio between a distance at which the first creation product data is assumed to be viewed and a distance at which the second creation product data is assumed to be viewed.

3. The information processing apparatus according to claim 1, wherein the generation unit determines a ratio of the enlargement or the reduction also based on a ratio between a font size of a representative text used in the first creation product data and a font size of a representative text used in the second creation product data.

4. The information processing apparatus according to claim 1, wherein the generation unit determines a ratio of the enlargement or the reduction such that an impression of the second creation product data becomes closer to an impression of the first creation product data.

5. The information processing apparatus according to claim 1, wherein a type of the second creation product data varies from a type of the first creation product data.

6. The information processing apparatus according to claim 2, wherein the generation unit complements the enlarged or reduced background information such that the background information fits a size of a background region in the second creation product data.

7. The information processing apparatus according to claim 2, wherein the generation unit adjusts the enlargement or the reduction of the background information such that a pattern change does not occur in a case where the background information is arranged in a background region in the second creation product data.

8. The information processing apparatus according to claim 1, wherein the generation unit generates the second creation product data such that a distance between a target impression and an impression estimated from the second creation product data is smaller than a predetermined threshold.

9. The information processing apparatus according to claim 1, wherein, in a case where the second creation product data includes a plurality of pieces of creation product data varying in type, the generation unit generates the second creation product data such that a total of distances between a target impression and impressions estimated from the respective plurality of pieces of creation product data varying in type is smaller than a predetermined threshold.

10. The information processing apparatus according to claim 1, wherein the one or more processors are further configured to function as:
a reception unit configured to receive designation of the first creation product data from a user; and
an obtaining unit configured to obtain a design element from the first creation product data received by the reception unit, wherein
the generation unit generates the second creation product data, based on the design element obtained by the obtaining unit.

11. The information processing apparatus according to claim 10, wherein the design element includes at least a target impression.

12. The information processing apparatus according to claim 11, wherein the design element further includes at least one of a color scheme, background information, a logo, and a font.

13. The information processing apparatus according to claim 10, wherein the reception unit receives designation of a type of the second creation product data.

14. The information processing apparatus according to claim 10, further comprising a display unit configured to display a first screen for receiving the designation of the first creation product data from the user.

15. The information processing apparatus according to claim 14, wherein the first screen further receives designation of the design element and designation of a type of the second creation product data from the user.

16. The information processing apparatus according to claim 15, wherein the display unit displays a second screen including the second creation product data generated by the generation unit.

17. The information processing apparatus according to claim 16, wherein the second screen further includes a region for receiving the designation of the first creation product data from the user and a region for receiving the designation of the design element from the user.

18. The information processing apparatus according to claim 1, wherein the generation unit combines design elements by using a genetic algorithm, and generates the second creation product data.

19. An information processing method executed by an information processing apparatus, the information processing method comprising:
generating second creation product data including background information of first creation product data and varying from the first creation product data at least in size, wherein
background information of the second creation product data is generated by enlarging or reducing the background information of the first creation product data such that a size ratio between the background information of the first creation product data and the background information of the second creation product data takes a value between 1 and a ratio between a size of the first creation product data and a size of the second creation product data,
in a case where the size of the second creation product data is smaller than the size of the first creation product data, a size of the background information of the second creation product data is smaller than a size of the background information of the first creation product data, and is larger than a size of the background information of the first creation product data that is reduced by the ratio of the size of the second creation product data to the size of the first creation product data, and
in a case where the size of the second creation product data is larger than the size of the first creation product data, the size of the background information of the second creation product data is larger than the size of the background information of the first creation product data, and is smaller than a size of the background information of the first creation product data that is enlarged by the ratio of the size of the second creation product data to the size of the first creation product data.

20. A non-transitory computer readable storage medium storing a program which causes one or more processors of a computer to execute an information processing method comprising:
generating second creation product data including background information of first creation product data and varying from the first creation product data at least in size, wherein
background information of the second creation product data is generated by enlarging or reducing the background information of the first creation product data such that a size ratio between the background information of the first creation product data and the background information of the second creation product data takes a value between 1 and a ratio between a size of the first creation product data and a size of the second creation product data,
in a case where the size of the second creation product data is smaller than the size of the first creation product data, a size of the background information of the second creation product data is smaller than a size of the background information of the first creation product data, and is larger than a size of the background information of the first creation product data that is reduced by the ratio of the size of the second creation product data to the size of the first creation product data, and
in a case where the size of the second creation product data is larger than the size of the first creation product data, the size of the background information of the second creation product data is larger than the size of the background information of the first creation product data, and is smaller than a size of the background information of the first creation product data that is enlarged by the ratio of the size of the second creation product data to the size of the first creation product data.
